(19) United States
(12) Patent Application Publication
(10) Pub. No.: US 2015/0170219 A1
(43) Pub. Date: Jun. 18, 2015

(54) APPARATUS AND METHOD FOR ON-LINE ADVERTISEMENT AND A CENTRAL SUBSCRIPTION MANAGEMENT SERVICE

(71) Applicant: Kyle Johnson, Lawrence, KS (US)

(72) Inventor: Kyle Johnson, Lawrence, KS (US)

(21) Appl. No.: 14/634,377

(22) Filed: Feb. 27, 2015

Related U.S. Application Data
(62) Division of application No. 13/772,186, filed on Feb. 20, 2013, now abandoned.
(60) Provisional application No. 61/601,170, filed on Feb. 21, 2012.

(51) Int. Cl. G06Q 30/02

(52) U.S. Cl. CPC G06Q 30/0269; G06Q 30/0276

(57) ABSTRACT

The disclosure relates generally to systems and methods optimize the creation and effectiveness of web-based advertisements. In particular a processing system provides a platform for the on line creation of advertisements and delivery platform that enables businesses, web content publishers, and consumers to view targeted advertisements. The consumers may in turn earn coupons or other rewards for interacting with the advertisements.

### RELATED APPLICATIONS

The present application is a divisional of U.S. patent application Ser. No. 13/772,186, filed Feb. 20, 2013, which claims the benefit of priority to U.S. Provisional Patent Application Ser. No. 61/601,170 filed Feb. 21, 2012, entitled “Apparatus and Method for On-line Advertisement and a Central Subscription Management Service, the entirety of each application identified above is incorporated herein by reference.

### FEDERALLY SPONSORED RESEARCH OR DEVELOPMENT

Not Applicable.

### COMPACT DISK APPENDIX

Not Applicable.

### BACKGROUND

Advertisements transmitted over the Internet and viewed on various web pages are often created by a retailer, service provider, or an advertisement company and then published to an advertisement server. The advertisement server typically receives requests from search engines and content providers, such as newspapers, or blog websites, to place advertisements on the search engine's or content providers' websites. These advertisements are then made available for viewing by Internet users. The advertisements are typically produced to have broad mass-appeal and are published on a large scale.

Often, these widely distributed advertisements do not reach the right audiences. Alternately, these advertisements simply fail to register with Internet users. As such, these online advertisements induce very few interactive behaviors by the viewers and therefore, may not generate new revenue for the retailers or service providers.

### SUMMARY

The present disclosure relates to systems and methods for creating and managing an online advertisement campaign that provides advertisers the ability to quickly and easily create advertisements online as well as the ability to identify a target audience for their advertisements. In one aspect, the systems and methods provide customers who view ads and web content publishers who sell advertising space the ability to identify preferred advertisements and advertisers. In another aspect, the systems and methods allow for advertisers, publishers, and customers to make purchases and receive payments or rewards through a central subscription management service.

In one embodiment, the system and methods are encoded in an application on a computer-readable media. The application includes modules executable by a processor and are configured to facilitate the creation of advertisements. The modules include an ad creation and storage module to receive an advertisement creation request from a computing device, create a targeted advertisement based on the advertisement creation request, generate a targeted advertisement record comprising advertisement data, and store the targeted advertisement in a database. The advertisement data includes demographic data and interest data of a target audience.

An assignment module generates a targeted advertisement reference for the targeted advertisement and assigns the targeted advertisement reference to the targeted advertisement. An advertisement view request module receives an advertisement view request from another computing device, identifies a user of the other computing device, and determines if the user of the other computing device is a member of a target audience for the targeted advertisement. A publication module transmits at least one of the targeted advertisement reference and the target advertisement to the other computing device for viewing by a customer.

In another embodiment, a system for creating targeted advertisements for display includes a database to store a plurality of targeted advertisement records, targeted advertisements, and targeted advertisement references, and other data. The system also includes a computing device executing the targeted advertisement application that further includes modules executable by the computing device. The modules include an ad creation and storage module to receive an advertisement creation request from a computing device, create a targeted advertisement based on the advertisement creation request, generate a targeted advertisement record comprising advertisement data, and store the targeted advertisement in a database. The advertisement data includes demographic data and interest data of a target audience.

An assignment module generates a targeted advertisement reference for the targeted advertisement and assigns the targeted advertisement reference to the targeted advertisement. An advertisement view request module receives an advertisement view request from another computing device, identifies a user of the other computing device, and determines if the user of the other computing device is a member of a target audience for the targeted advertisement. A publication module transmits at least one of the targeted advertisement reference and the target advertisement to the other computing device for viewing by a customer.

A method for providing a targeted advertisement campaign for display in online content that may be hosted on a server computing device and operated by a publisher is also disclosed. The method includes receiving an advertisement creation request at a processor from a first computing device. The advertisement creation request includes advertisement data, ad layout data, and one or more media files. The method also includes creating one or more targeted advertisement records, where each record includes the advertisement data and at least one of the one or more media files, and creating one or more targeted advertisements, where each advertisement includes at least one of the one or more media files. The one or more targeted advertisement records and the one or more targeted advertisements are stored in a database.

At least one targeted advertisement reference is assigned to at least one of the one or more targeted advertisements and the at least one targeted advertisement reference is also stored in the database. The method also includes receiving an advertisement view request from a second computing device. The advertisement view request identifies an ad unit layout within the online content. A user of the second computing device and a recommended advertisement are identified. The recommended advertisement is at least one of the one or more targeted advertisements having ad layout data that matches the ad unit layout.

The method further includes determining that the user of the second computing device is a member of a target audience for the recommended advertisement and transmitting the at least one targeted advertisement reference assigned to the recommend advertisement to the server computing device for display in the online content. Subsequently, it may then be determined if a user of the second computing device interacts with the recommended advertisement.

### BRIEF DESCRIPTION OF THE DRAWINGS

FIG. 1A is a block diagram of a computing environment for creating and publishing targeted advertisements according to one aspect of an advertisement targeting optimization system.

FIG. 1B is a block diagram of a computing environment for creating and publishing targeted advertisements according to one aspect of the advertisement optimization system.

FIGS. 2A-2Q are screenshots of user interface displays for provided to an advertising entity according to one aspect of a targeted advertisement optimization system.

FIGS. 3A-3F are screenshots of user interface displays for provided to a customer according to one aspect of a targeted advertisement optimization system.

FIGS. 4A-4F are screenshots of user interface displays for provided to a content publishing entity according to one aspect of a targeted advertisement optimization system.

FIG. 5 is a block diagram of a targeted advertisement record according to one aspect of a targeted advertisement optimization system

FIG. 6 is a block diagram of an advertisement creation application according to one aspect of a targeted advertisement optimization system.

FIG. 7 illustrates a method for creating and publishing targeted advertisements according to one aspect of a targeted advertisement optimization system.

FIG. 8 illustrates a method for creating and managing a targeted advertisement campaign according to one aspect of a targeted advertisement optimization system

FIG. 9 illustrates a method for publishing and tracking a reaction to a targeted advertisement according to one aspect of a targeted advertisement optimization system.

### DETAILED DESCRIPTION

The present disclosure relates to a systems and methods for creating and publishing targeted advertisements or ads, as well as systems and methods for redeeming coupons and rewards associated with the targeted advertisements. In one aspect, the systems and methods are executed and performed on an advertising platform that allows users to share data and optimize the targeting and display of on-line advertisements. The platform or targeted advertisement optimization (TAO) system is a self-serve ad creation and delivery platform that enables businesses to easily create digital advertisements. The TAO system then distributes these advertisements through various content publishers and content owners to targeted subsets of internet users using advanced targeting methods. By interacting with the targeted advertisements, internet users or customers can receive discounts and rewards from the businesses.

In one aspect, the TAO system enables businesses to target users by creating advertisements that they believe will appeal to an Internet users having certain demographics and interests. These ads may only be published for viewing by users whose demographics and/or interests match the desired demographics and interests specified by the business.

In another aspect, the TAO system enables businesses to elicit a wide variety of interactive, online behaviors by customers. The business-created advertisements can deliver a simple impression with the potential for interaction, such as a click-through action by the customer. As used herein, an impression refers to the display of an ad, regardless of whether it is clicked on or not. Additionally, the business can use the TAO system to serve ads in form of coupons, games, surveys, or other formats, including a “Get Followers” advertisement that is designed to get customers to follow the business on Facebook, Twitter, and other interactive social media networks. In exchange for these interactions, the customers may receive rewards from the businesses. For example, the rewards may include free merchandise, discounts on merchandise, loyalty program “points” (e.g. airline miles, hotel points), and premium content, among others. The TAO system allows businesses to create a variety of advertisements including but not limited to banners, emails, and other formats. The ads may include audio, video, still images, or other scripts and applications.

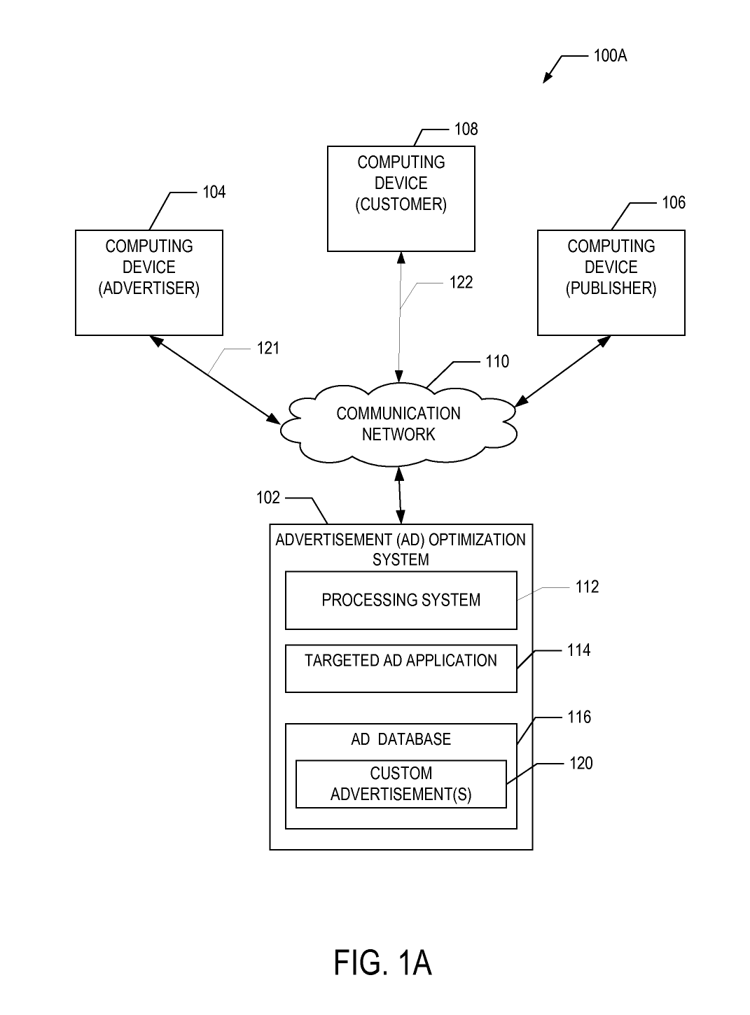

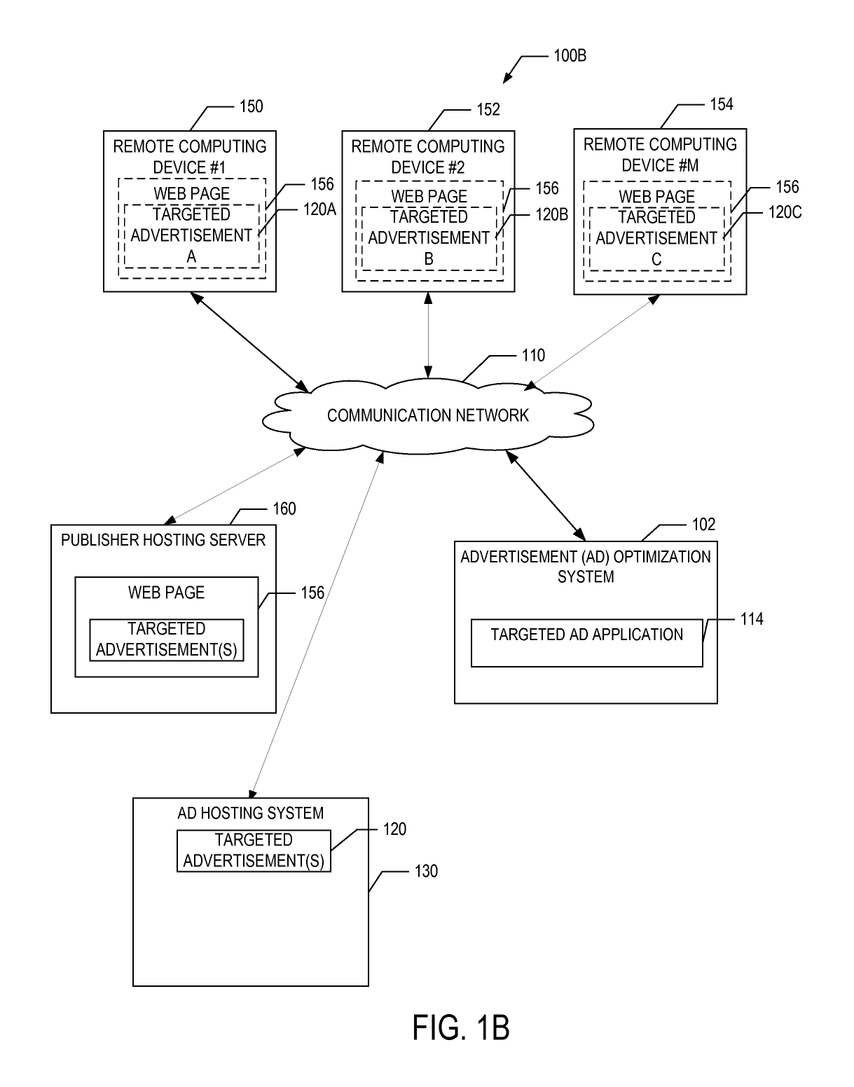

FIG. 1A is a block diagram of an exemplary operating environment 100A for creating, managing, and delivering advertisements. The operating environment 100 includes an optimized targeted advertisement (TAO) system 102 and computing devices 104-108 that communicate with the TAO system 102 over a communication network 110. The communication network 110 can be the Internet, an intranet, or another communication network. For example, the TAO system 102 and the computing devices 104-108 communicate data over the communication network 110 using a Hyper Text Transfer Protocol (“HTTP”) or another communication protocol. For example, each computing device 104-108 has an associated input device (not shown) for entering or selecting data and an associated display (not shown) for viewing data and/or forms. The input device can be a keyboard or a pointing device (e.g., a mouse, trackball, pen, or touch pad) and the display can be computer monitor.

Although computing devices 104-108 are depicted as communicating with the TAO system 102 via a single communication network 110, in other aspects it is contemplated that computers 104-108 may communicate with the TAO system 102 via separate communication networks, including but not limited to a local area network (LAN) or an intranet.

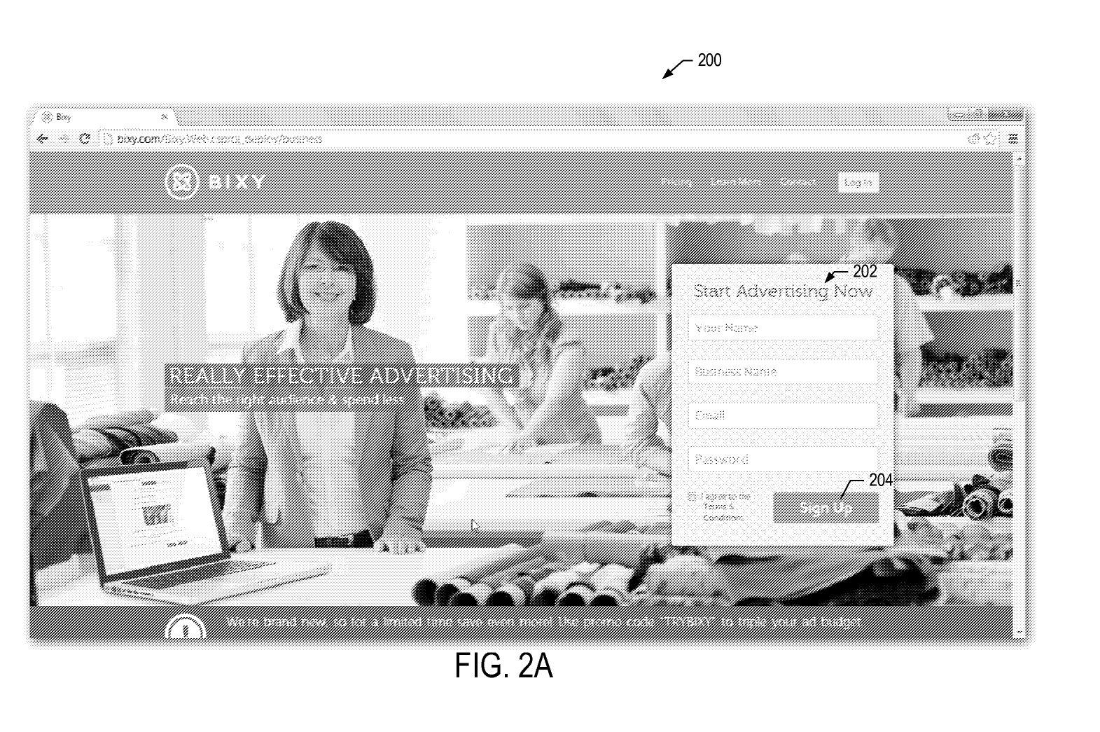

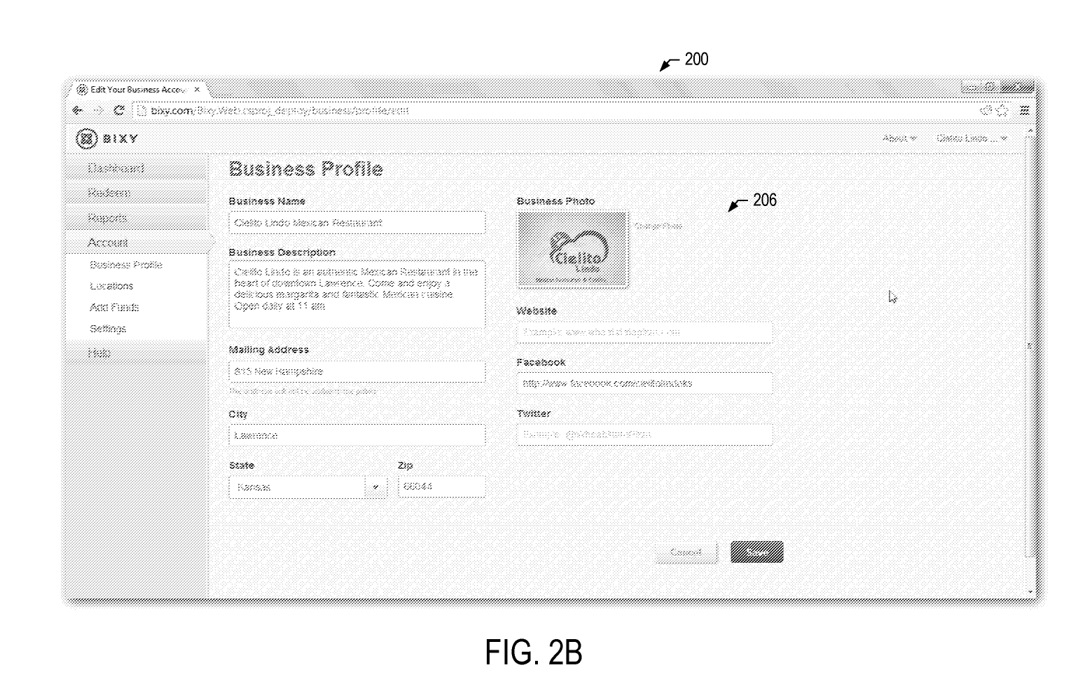

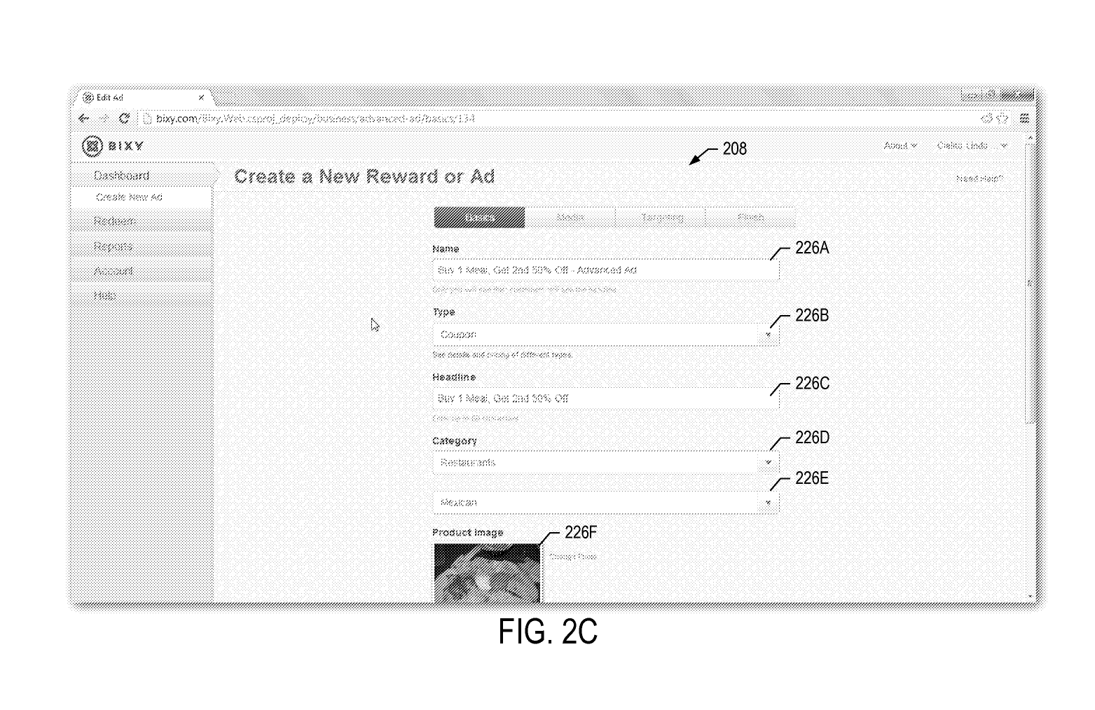

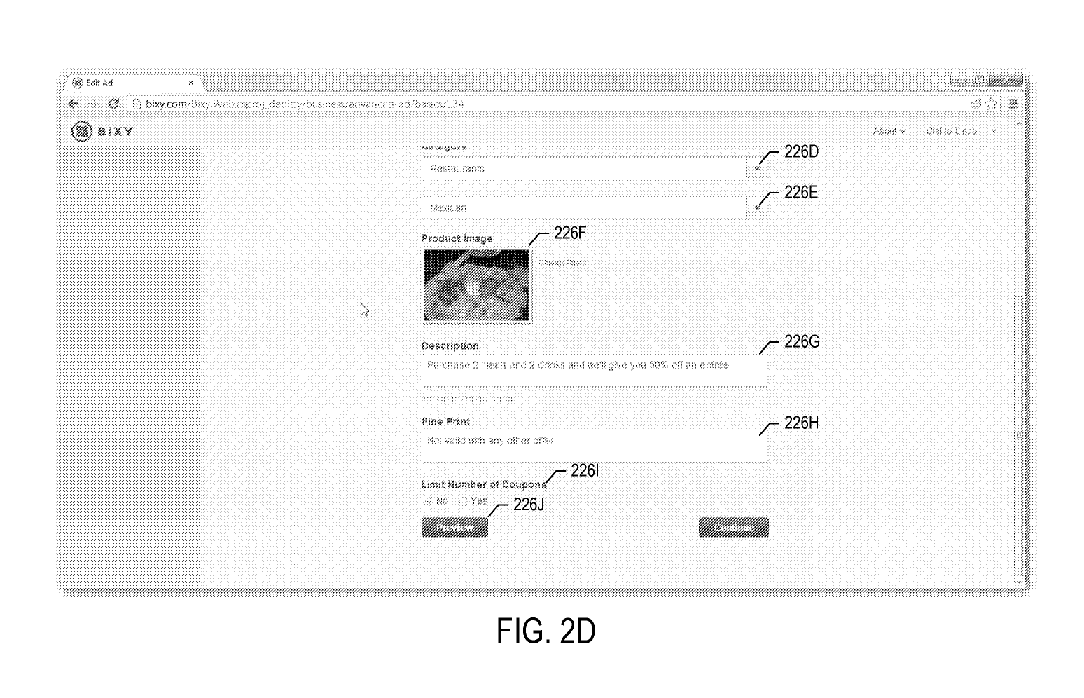

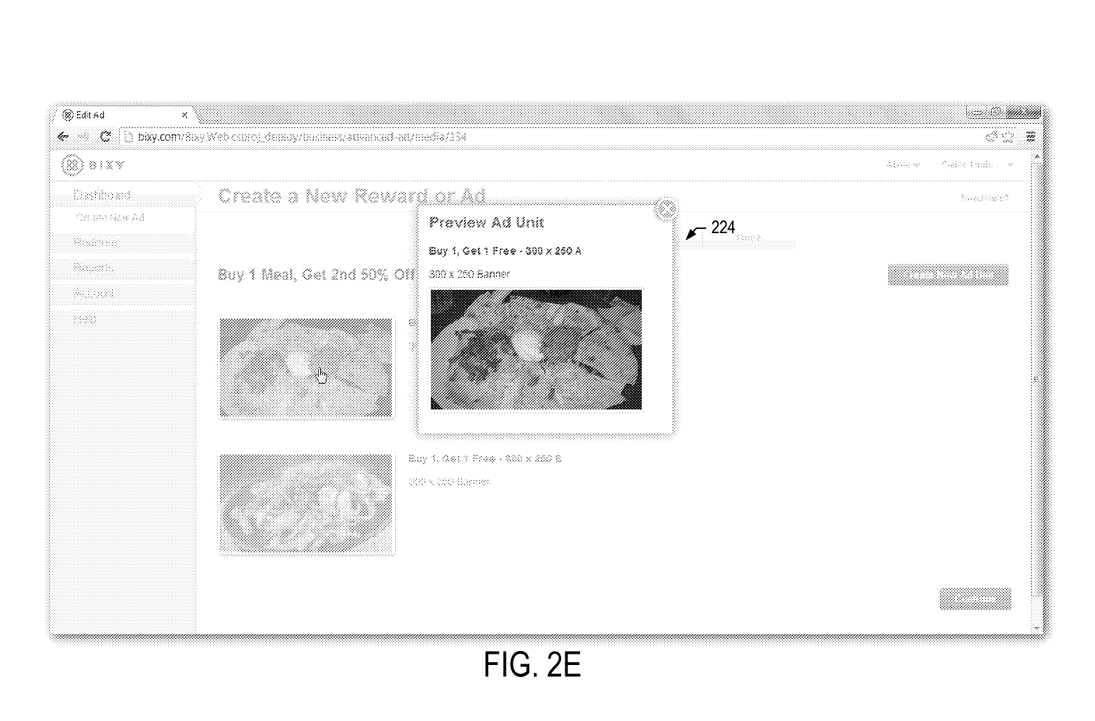

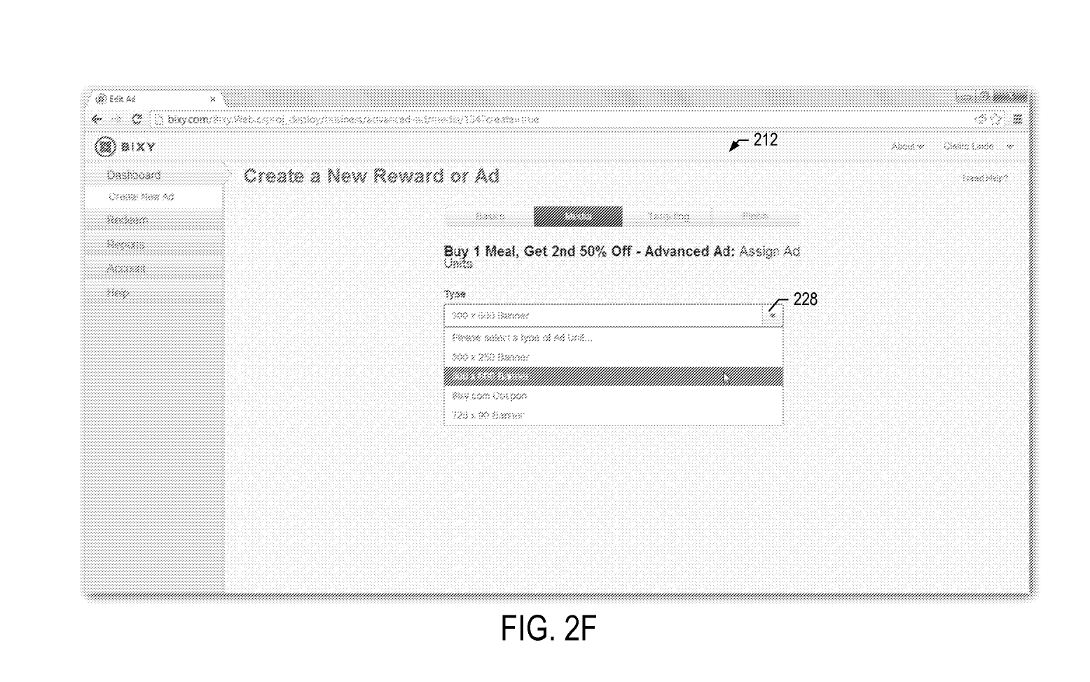

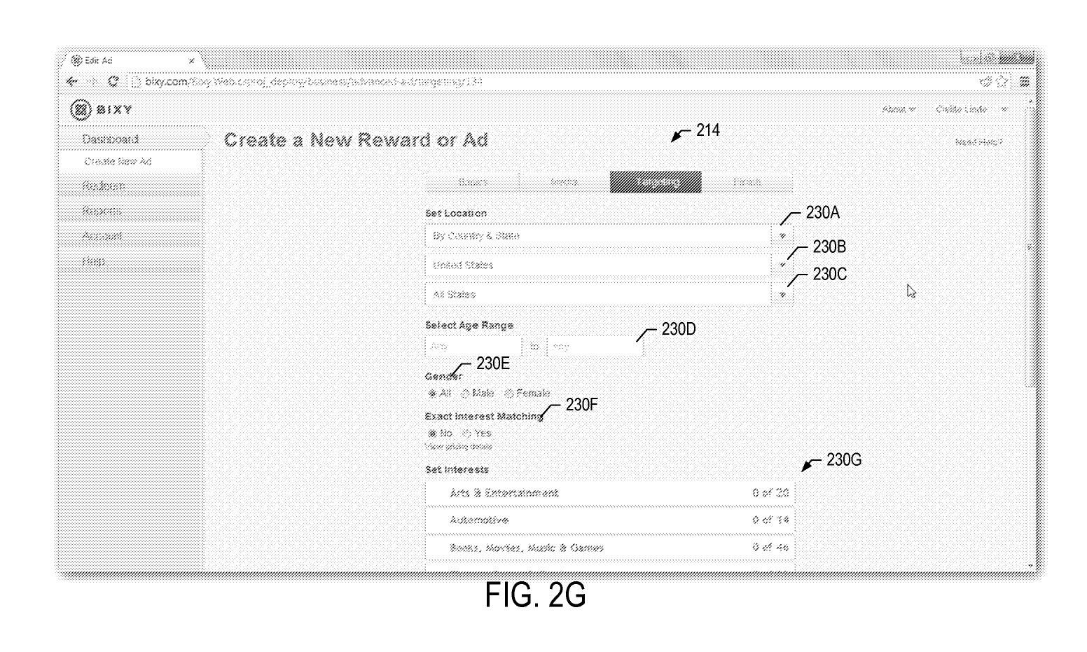

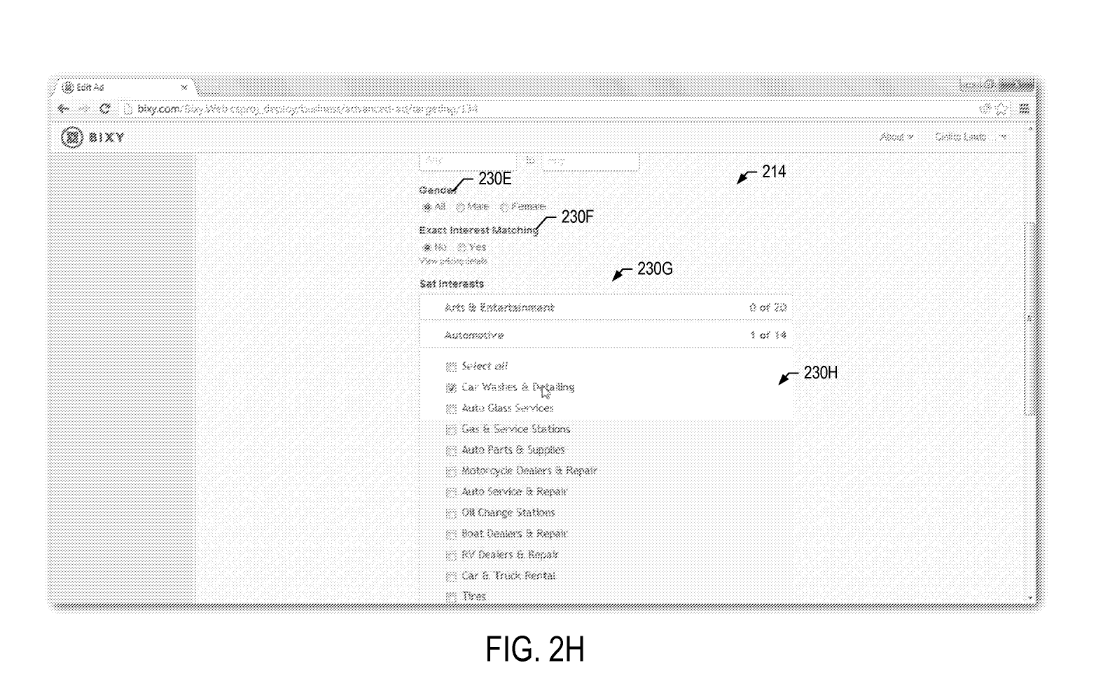

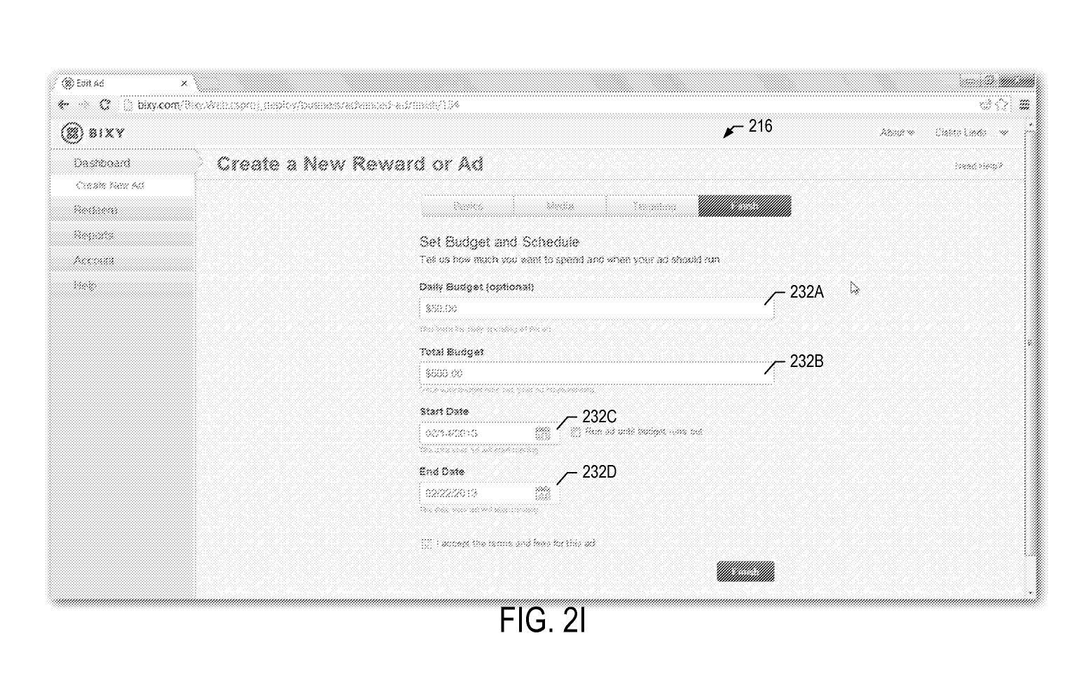

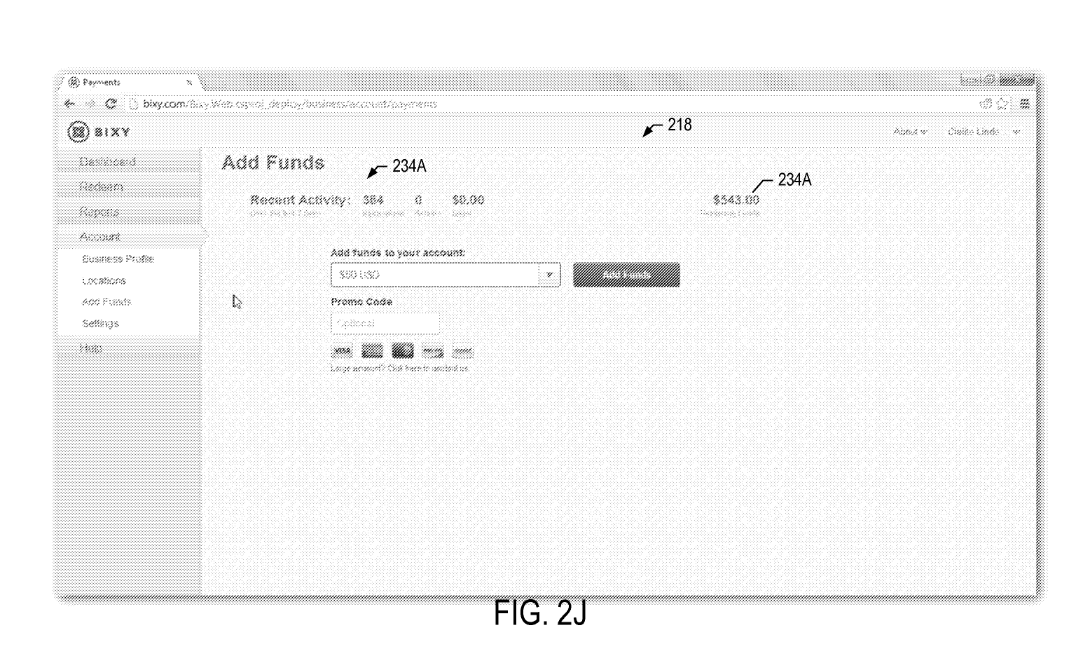

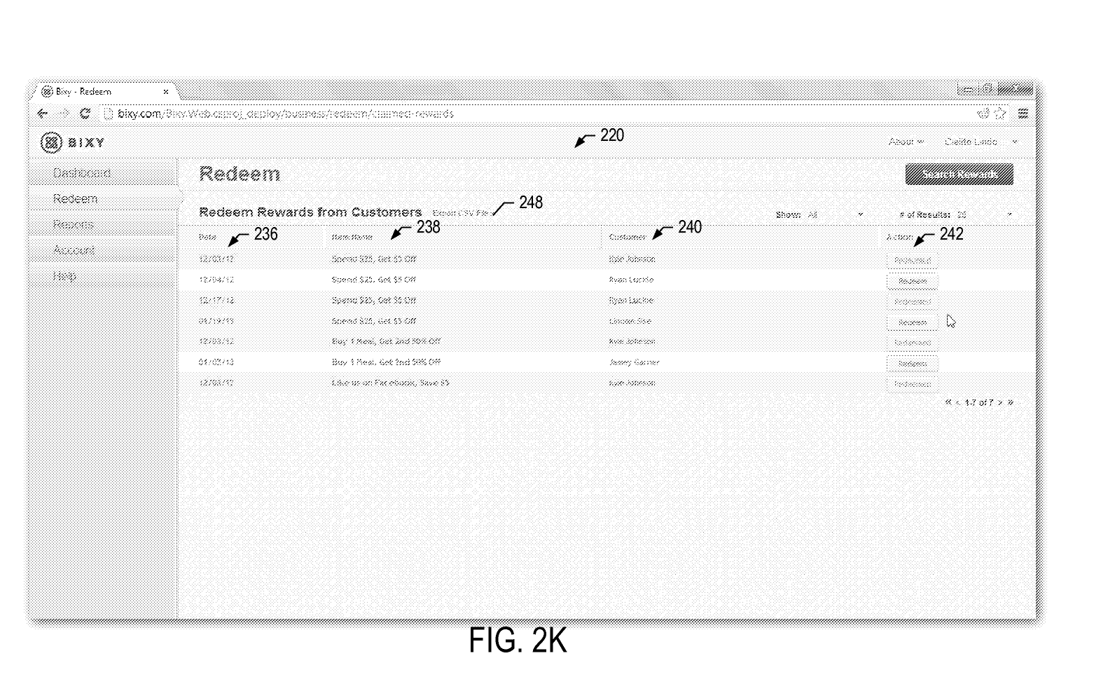

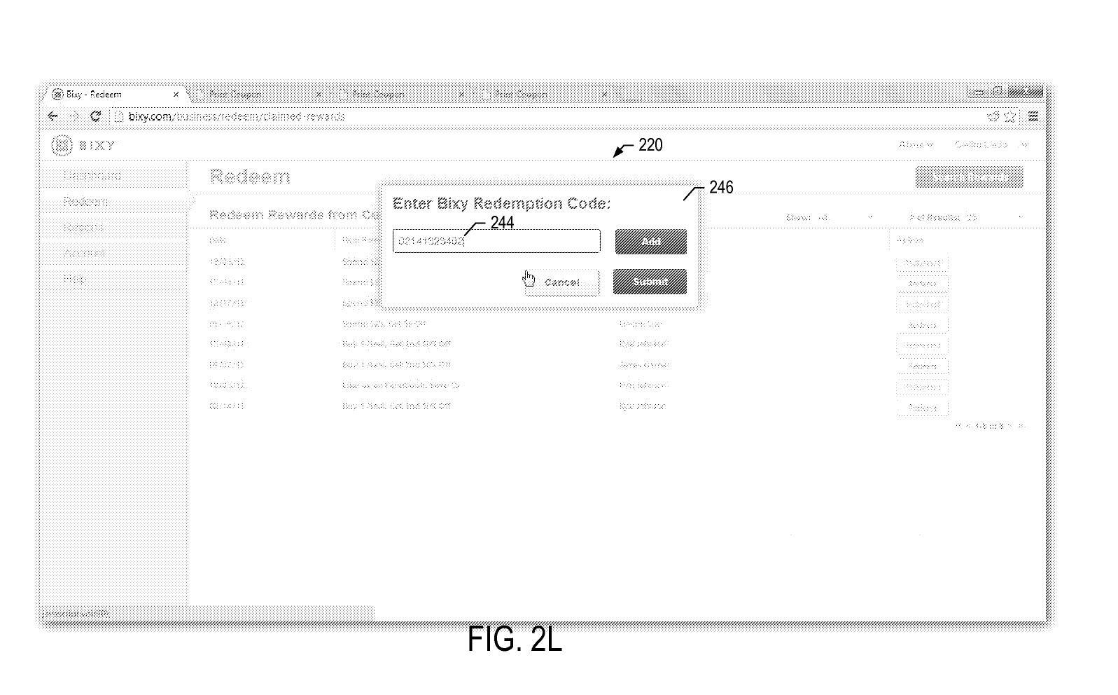

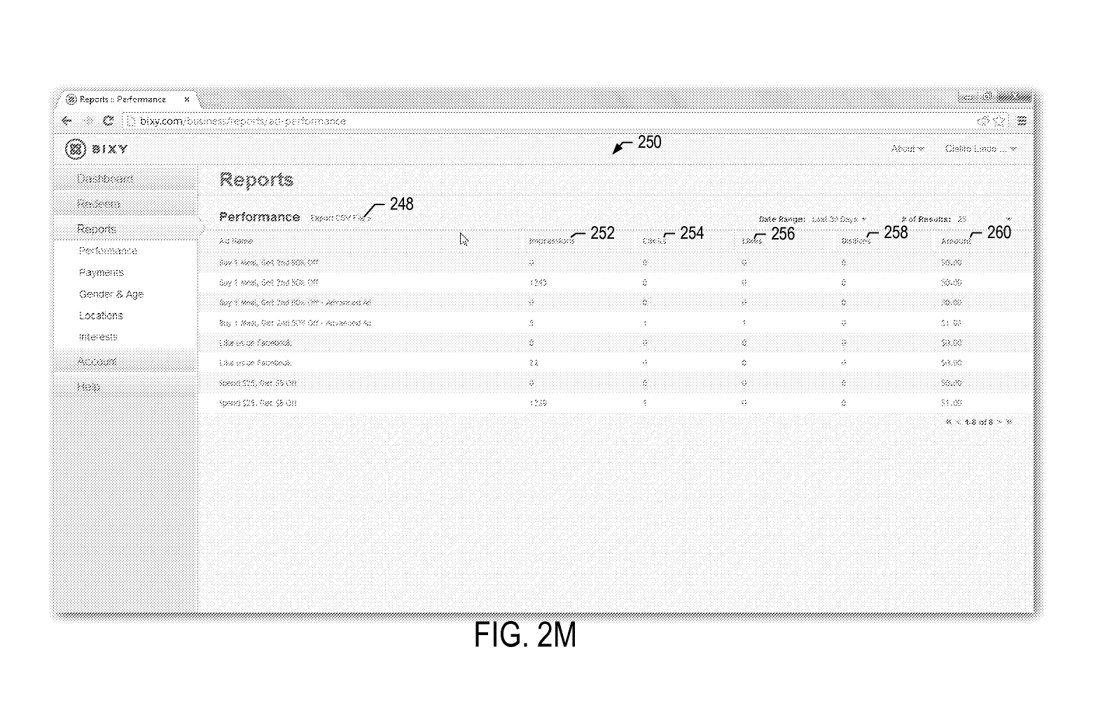

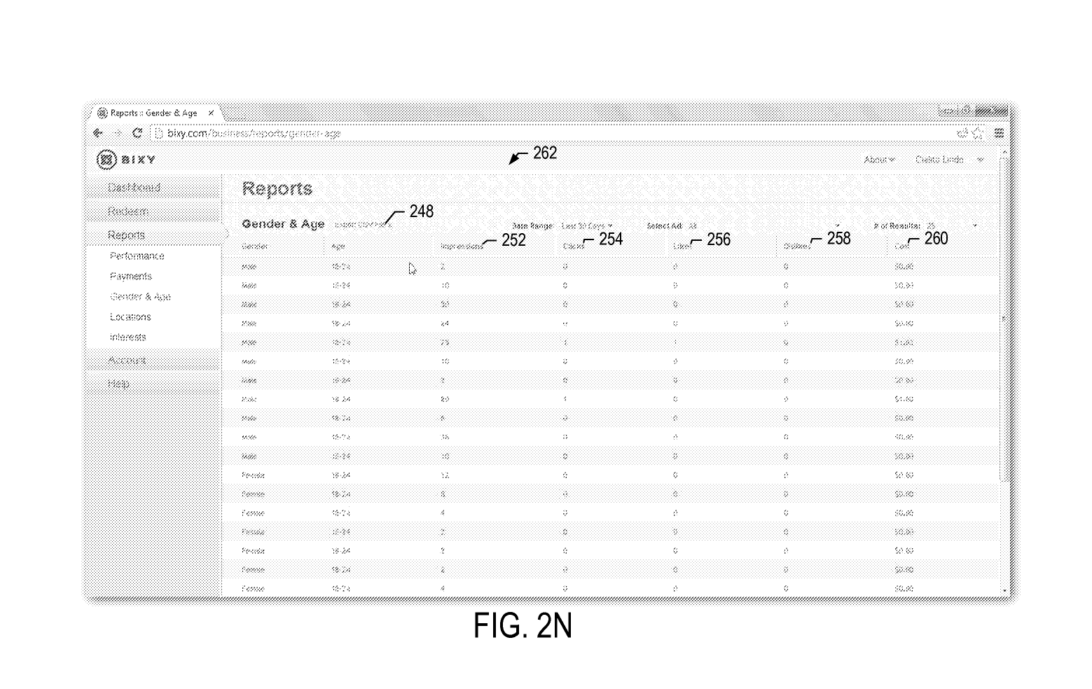

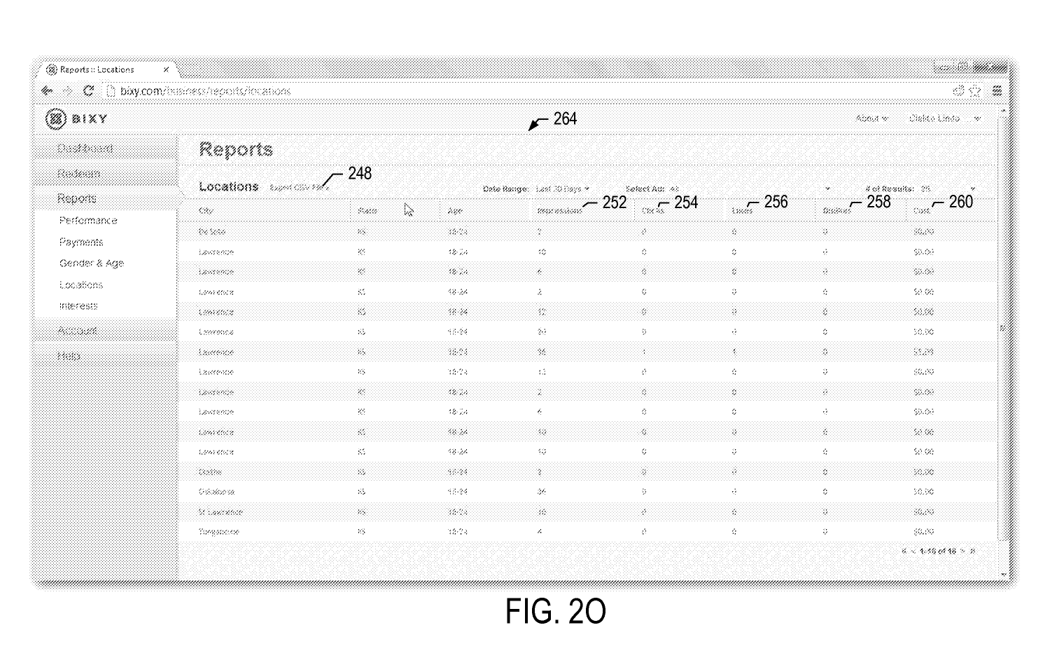

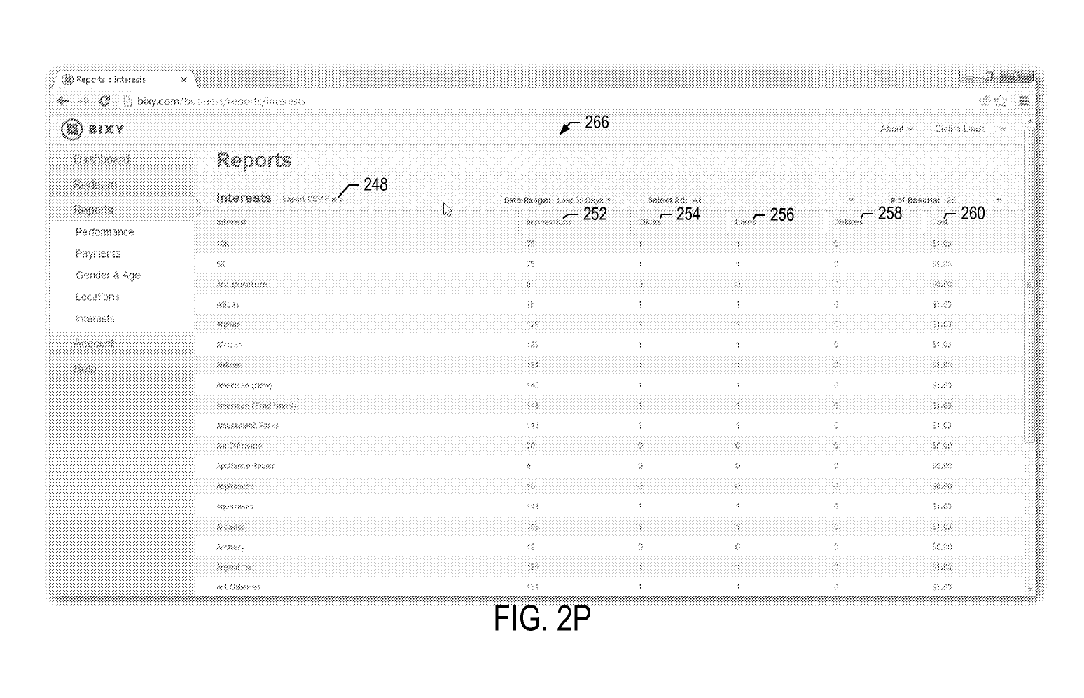

The TAO system 102 provides a targeted Internet-based advertisement service that can be accessed by a user of the computing device 104 that transmits an ad creation request 121 via the communication network 110 to create advertisements and to fund the purchase of advertising opportunities. In one aspect, the TAO system 102 includes a processing system 112 to execute a targeted advertisement application 114. The targeted advertisement application 114 generates one or more web portals 200, 300, and 400 as shown in FIGS. 2A, 3A, and 4A, respectively. Each web portal 200, 300, and 400 includes a plurality of graphical user interface displays that are transmitted to the computing devices 104-108 for display to the users thereof, for viewing and inputting data. The web portal presented depends upon the type of user at the computing devices 104-108. For example, the TAO system 102 presents different information to a user who is a business owner or advertiser, such as the user of the computing device 104, a web-based content publisher such as the user of the computing device 106, and a customer or customer, such as the user of the computing device 108.

An advertiser may be a proprietor or representative of a business, or alternately, an advertising company contracted by one or more business. Typically, the advertiser desires to create an advertisement for a particular good or service provided by the business to display on websites or other media owned or operated by a publisher. As used herein, a publisher refers to the owner or operator of a website, software application, or other content provider that sells advertising space or advertising opportunities to monetize its product. For example, an online news website may choose to display ads to its users in order to generate revenue similar to the way traditional newspapers generate revenue from ads. In addition, publishers can also include distributers of video content, audio content, games, other online multimedia, as well as produces of applications or “apps” for mobile devices.

The TAO system 102 includes an ad database 116 that stores data regarding the users of the system as well as the advertisements created and published by the system. The user data is associated with a profile created by the users of the computing devices 104-108. In one embodiment, the database 116 also stores the customized or targeted advertisements 120.

In another embodiment, as shown in FIG. 1B, the targeted advertisements are stored on an ad hosting system 130. The ad hosting system 130 may be any server or data storage device. The ad hosting system may be physically located in a different location than one or more other components of the TAO system or the computing devices 104-108, and may communicate with the computing devices or the TAO system through the communication network 110. In one aspect, the TAO system 102 may communicate directly with the ad hosting system 130.

In one aspect, an advertiser using the computing device 104 communicates with the TAO system 102 to create the targeted advertisement 120. The TAO system 102 then receives an advertisement view request 122 from a customer using the computing device 108. The TAO system 102 receives the advertisement view request 122 and may use it to identify the customer and to determine if the customer is a suitable audience target for the targeted ad 120. The TAO system 102 provides the publisher with a reference to the target advertisement, so that it may be seamlessly inserted into the content viewed by the customer.

In another operating environment 100B, as shown in FIG. 1B a number of customers may be using computing devices 150-156 to view content in a one or more web pages hosted by a server computing 160 operated by a publisher over the communication network 110. For example, each user of the remote computing devices 150-154 communicates with the server computing device 160 to view the web page 160. The TAO system 102 communicates with the server computing device 160 to determine the Internet Protocol address (IP address) for each user of the remote computing devices 150-154. The TAO system 102 may then determine the location of each user, or as explained below, the TAO system may identify demographic data and interests for each user. The TAO system 102 then transmits one or more targeted advertisements 120A-C for each user. As shown, the same web page 156 may contain different target advertisements 120A-C for the users of the remote computing devices 150-154.

According to one aspect, the targeted advertisement application 114 stores the created advertisement in an advertisement database 116. The targeted advertisement application 114 also generates a targeted advertisement reference 118 and a targeted advertisement record 119. The targeted advertisement reference 118 is a value or data string that identifies the location of the created ad for retrieval. In one aspect, the targeted advertisement reference 118 is a uniform resource locator (URL). For example, the advertisement created by the advertiser may be stored in the advertisement database 116 or, in another aspect, stored in an advertisement hosting system 130, as shown in FIG. 1A and identified by the targeted advertisement reference 118. The targeted advertisement reference 118 may then be inserted into the source file or source code for a product operated by the publisher. For example, the targeted advertisement reference 118 may be inserted into or at least references in the Hypertext Markup Language (HTML) or Extensible Markup Language (XML) file, among others, of a webpage generated by the publisher. In this example, the targeted ad is seamlessly presented within the publisher's webpage.

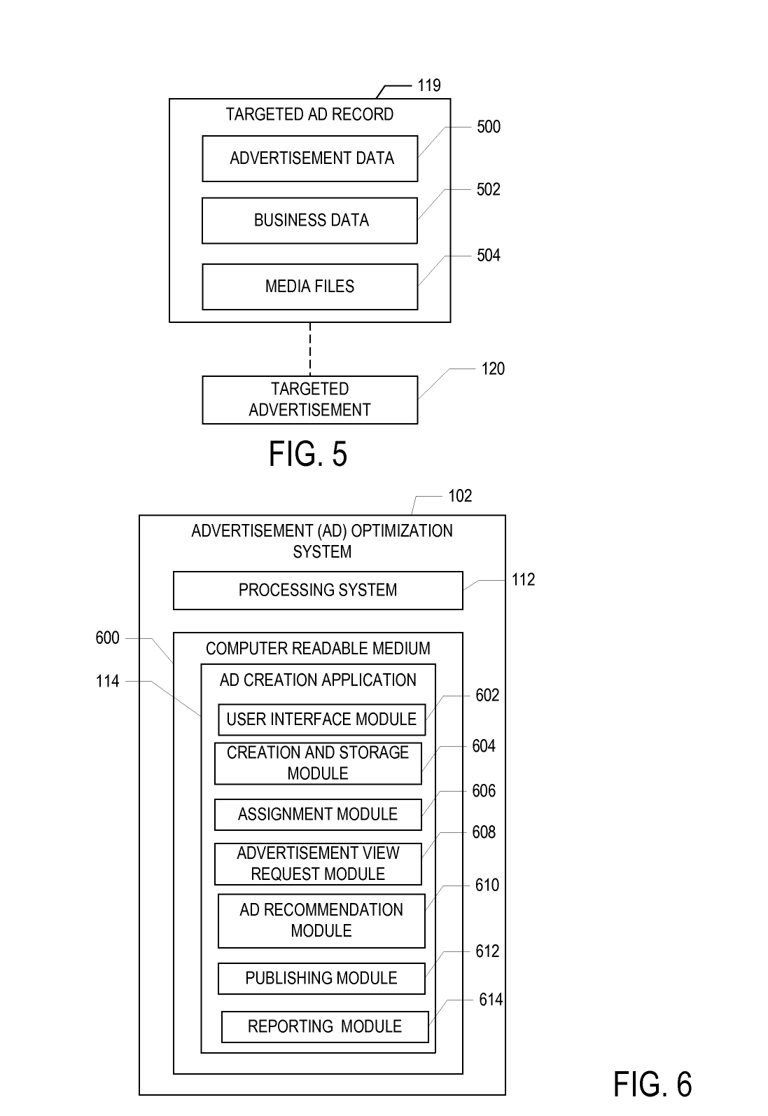

After creation, each targeted advertisement 120 also stored with or at least associated with the targeted advertisement record 119. In one aspect, the targeted advertisement record 119, as shown in FIG. 5, includes advertisement data 500 that further includes the demographic information and interests of advertisements target audience and, optionally, business data 502 that identifies the advertised business and any associated rewards or coupons. In addition, the advertisement data 500 may include information about the type of advertisement desired, the advertisement layout, and information about the product(s) and/or service(s) provided by the business, while the business data 502 may include the name of the user or a business representative, an email address, a phone number, a mailing address, and other contact information for the business.

In one aspect, the targeted advertisement record 119 may also include any media files 504, including but not limited to audio, video, photographs, text, or other files or applications that may be executed during the viewing of the advertisement that are combined to create the targeted advertisement 120. For example, the TAO system 102 compiles or assembles the media files 504 and advertisement data 302 into the targeted advertisement 120 just prior to publication. In another aspect, the advertiser provides the component media files 504 in a single data file for the targeted advertisement 120.

In order to create the advertisements, identify the desired audience, and purchase advertising opportunities or impressions, an advertiser, using the computing device 104, accesses the TAO system 102 through a web portal 200, that includes a number of graphical user interface displays and forms, such as the sign-up form 202 as shown in FIG. 2A. The web portal 200 also allows the advertiser to sign-up as a user of the TAO system 102. The advertiser may then create an advertiser profile that is associated with a user account for the TAO system 102. The advertiser may input identifying or credential data, including but not limited to a user's name, the business name, an email address, and a password into the form 202 and click on a control 204 to begin the process of creating an advertiser profile on the OTA system 102.

An advertiser profile is generated when the user inputs business data about the advertised business into the interface form 206, as shown in FIG. 2B, business data includes information about the business such as a mailing address, any associated websites, and social media networks. The web portal 200 may also be used to provide location information for business having multiple locations and contact information that, optionally, may be displayed publicly to other users of the TAO system 102.

The TAO system 102 also allows the user of the computing device 104 to create an ad campaign through the web portal 200. When creating an advertisement, as described below, with reference to FIGS. 2C-2J, the TAO system 102 receives an advertisement creation request 121 from an advertiser, who may then select an ad type, media formats (e.g. banner, video, audio), a potential customer reward, and demographic and interest data for the desired audience. In one aspect, the TAO system 102 will build the advertisement in response to the advertisement creation request 121 and data input by the advertiser at the computing device 104. The advertisers may further customize the advertisements by providing product names, discount amounts, and coupon expiration terms, among others. Similarly, survey-type advertisements allow the advertiser to submit their own questions. As the ad is built, the TAO system 102 generates a display of the ad for the advertiser to review. In one aspect, and advertiser may elect to create a simple advertisement that is available only on the TAO system 102 for customers. Conversely, the advertisers may elect create a more advanced advertisement for a targeted audience.

Examples of the advertisement creation user interface displays and forms 208 and 212-216, generated by the TAO system 102 are shown in FIGS. 2C-2I. An initial advertisement creation interface form 208, shown in FIGS. 2C-D, includes a number of data entry fields and controls 222A-222J that allows the advertiser to create an online advertisement. In one aspect, the advertiser can input data related to the name of the ad, the type of advertisement, a headline for the advertisement, a category and sub-category for the types of good or services provided, and a field to upload a picture or other media for the ad. The advertisement can include a video, one or more still images, and/or audio files provided by the user. In another aspect, the advertisement may include media selected by the TAO system 102. The form 208 also includes fields and controls to enter a description for the ad and to input any terms and conditions or other fine print for the ad. The advertiser may also limit the number of coupons and generate a preview 224 of the ad, as shown in FIG. 2E.

The user interface display 212, shown in FIG. 2F includes an input field 228, where the advertiser may select the size of the advertisement. In one aspect, the advertiser may select from several layout dimensions commonly used in on-line advertising. By way of example, and not limitation, the layout dimensions may be include 600×400 pixels, a 728×90 pixel banner up to a 300×600 pixel banner. In other aspects, any other layout configuration may also be used.

The user interface display 214, shown in FIGS. 2G-H includes a number of input fields 230A-230, where the advertiser may identify demographic data and interest data for a target audience for the advertisement. The target audience may be identified by a geographic location or by a proximity to a particular location, including one or more locations for the advertised business. In addition, the target audience may be identified by an age, range of ages, gender and customer interests. By way of example and not limitation the customer interests may be categorized into a tree-structure under broad categories such as Arts & Entertainment; Automotive; Books, Movies, Music & Games; Fitness & Sports; Health & Beauty; Kids & Family; Restaurants; Shopping; Services; and travel, among others. The customer interests within these broad categories may be further delineated into more narrowly-defined interests 230H as shown in FIG. 2H.

The user interface display 214 also includes an input form 230G, where the advertiser may indicate the stringency of the matching the target audience to the targeted advertisement. In one aspect, an exact match with display the created ad to only those customers that match all of the demographic and interest criteria input in the form 214. In this aspect, the advertisement is likely to be more successful in inducing a customer response than ads shown to an audience with broader matching criteria. As explained below, the costs of an exact matching ad campaign may be greater than a normal less stringent ad campaign.

User interface display 216, shown in FIG. 2I includes input fields 232A-232D, where the advertiser may determine an advertising budget for the created ad. An advertiser may elect to impose a daily budget on the ad campaign to ensure that all of the funds provided for the campaign are expended in a single day or other period. In addition, the advertiser may indicate the total budget for the campaign and a start and end date for the campaign.

In one aspect, the advertisers prepay or fund an advertising campaign prior to the publication of any ads. For example, the advertisers may deposit funds into an account associated with their advertiser profile on the TAO system 102. User interface display 218, as shown in FIG. 2J, includes input fields and controls where the advertiser may fund their account. The account may be funded in any suitable manner, including but not limited to payments made by credit card, PayPal or other electronic payment methods. The form 218 also indicates the funds 234A remaining in the advertisers budget and any recent ad campaign activity 234B that may have resulted in funds being debited from the account. In various other aspects, the advertiser may submit payment for the advertising campaign after the ads have been published.

After creating an advertisement by inputting data into forms 208-218, the targeted advertisement is generated and stored by the OTA system 102. According to another aspect, the advertisement data and/or business data may be collected via a telephonic communication, fax, a mail delivery service, or in-person. For example, the proprietor or representative of the business may provide the advertisement data and/or business data to an administrator or authorized user of the TAO system 102 during a telephone and/or an in-person conversation.

While FIGS. 2A-J depict user interface displays used to create one example of a target advertisement, the OTA system 102 may be used to create a number of different advertisement types. For example, the advertiser may create an Impression ad, where the Customer can click on the ad and visit a web page. A coupon ad may be created where the Customer can click the ad to get a coupon and redeem the coupon with the advertised business. A survey ad allows the customer can fill out a survey with questions created by the advertiser or business, while a “Get Followers” ad, allows the Customer to follow the advertised business on Facebook, Twitter and other social media networks and to subscribe to the advertised business's email list. Similarly, a “preferred brand” ad allows the customer to identify the advertised business as a preferred brand. This indication allows the customer to receive marketing messages and offers from the advertised business automatically.

A “share me” ad allows the Customer to share information about the advertised business via Facebook, Twitter and other social media networks or via email and text message. A game-type ad, allows the customer can play a game sponsored by the advertised business. The sponsored content ad presents the customer a video, audio, text-based, or multimedia presentation sponsored by the advertised business, while a content recall ad rewards the customer for answering questions correctly in reference to a multimedia presentation presented to them.

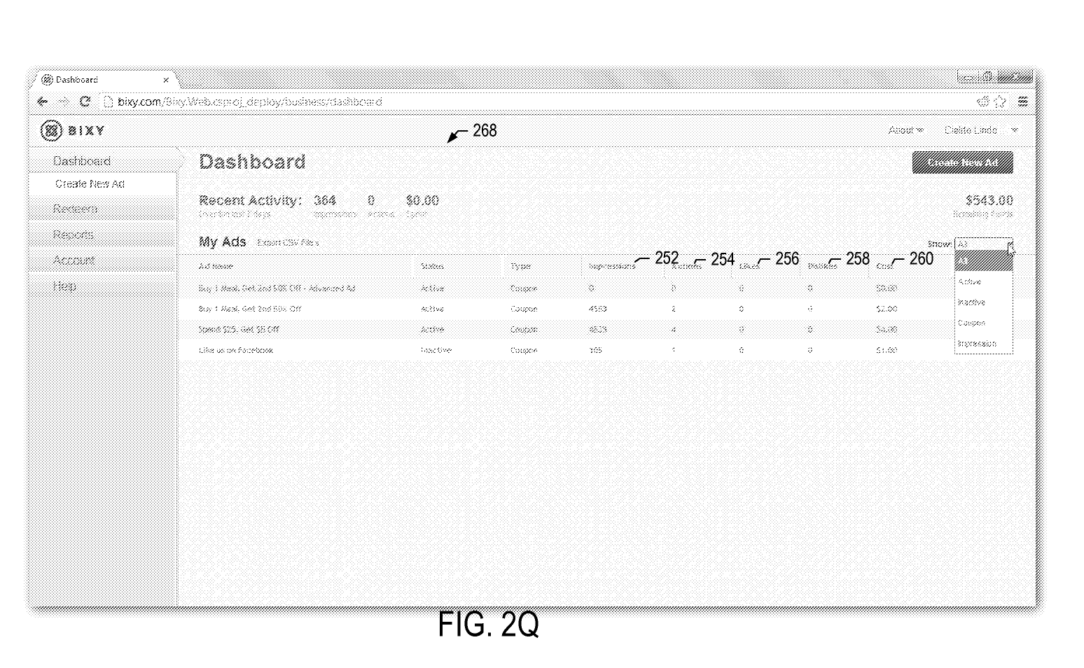

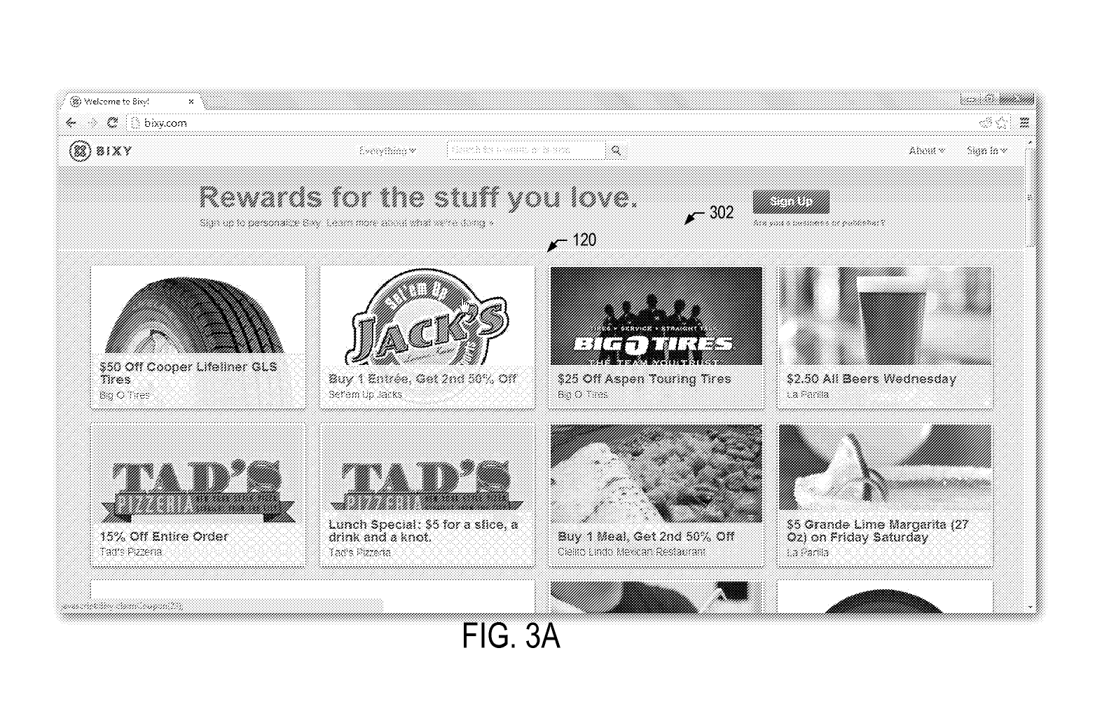

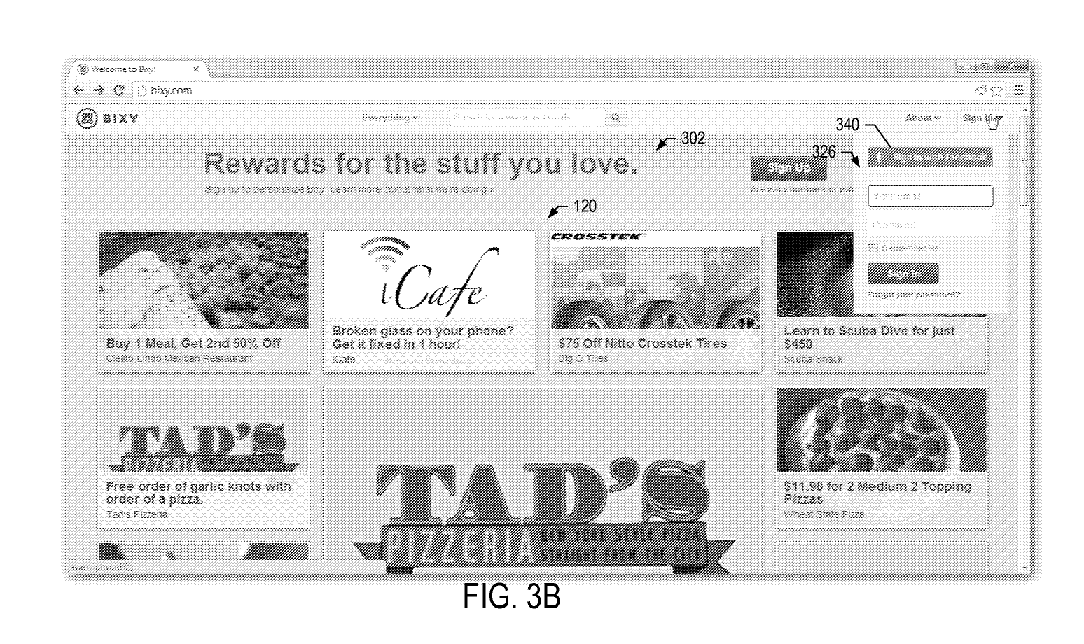

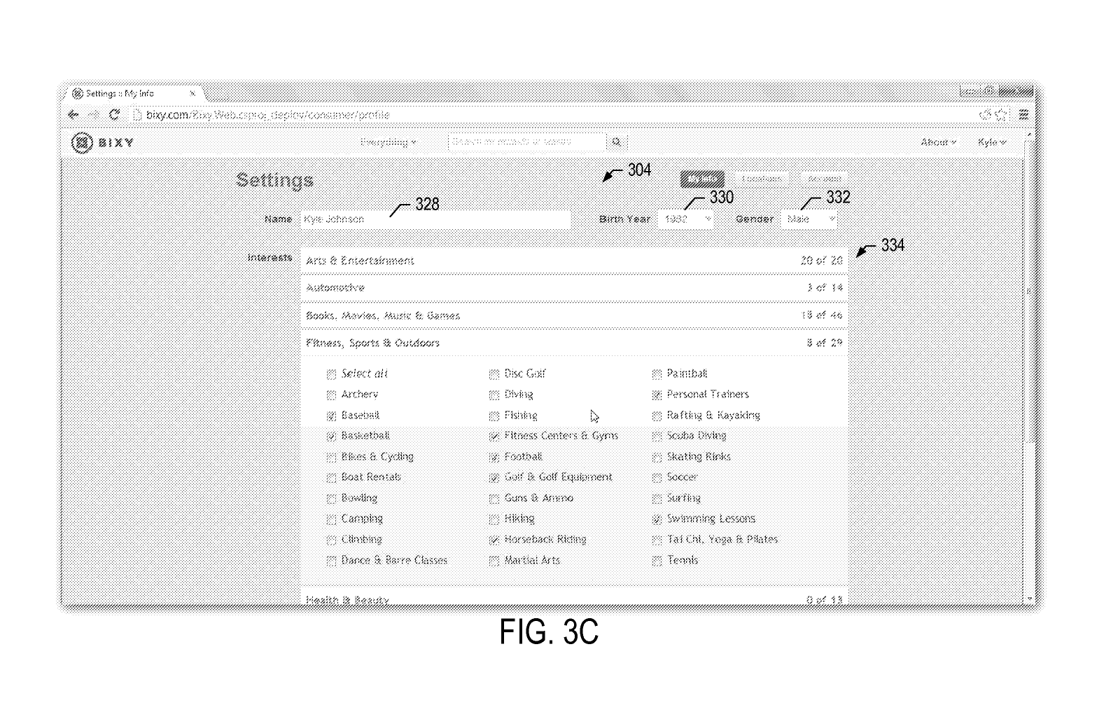

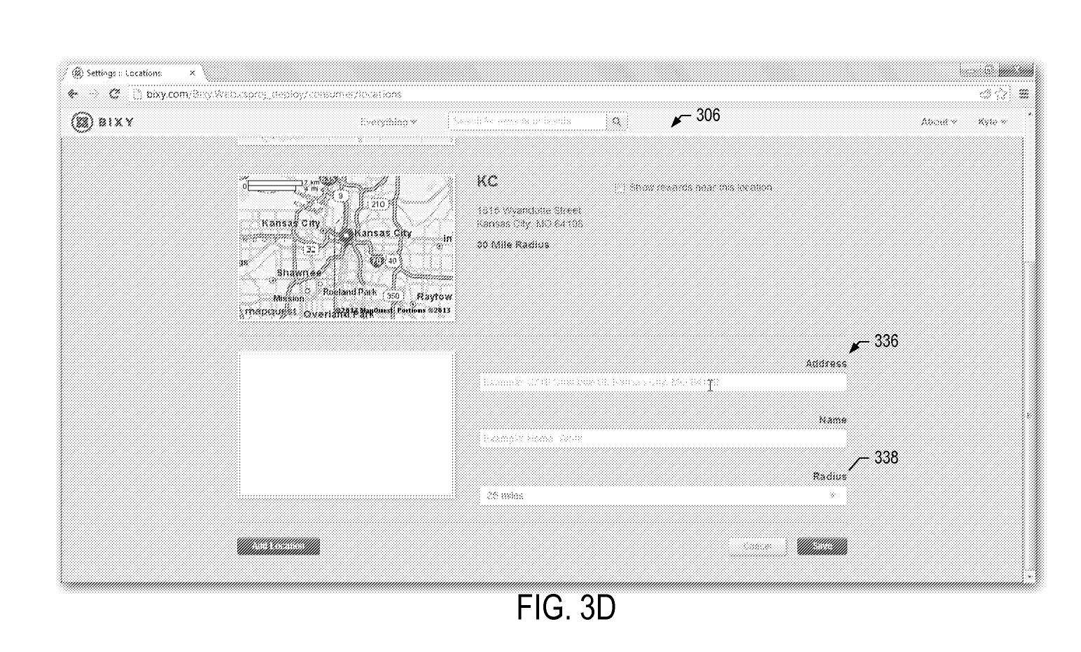

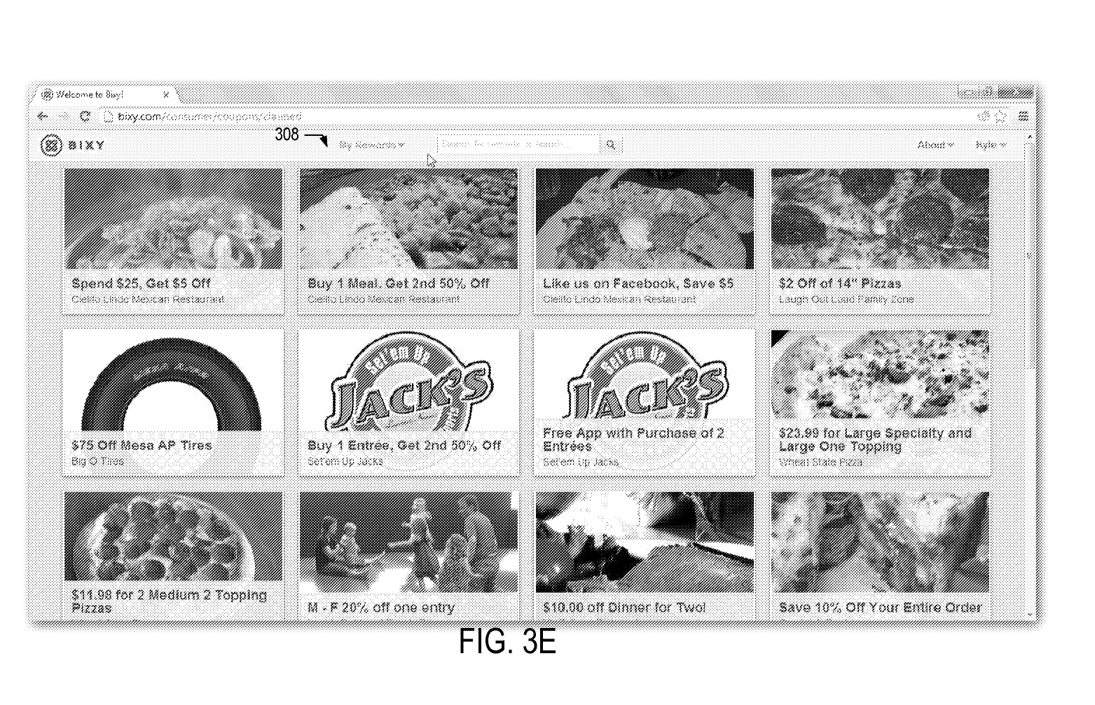

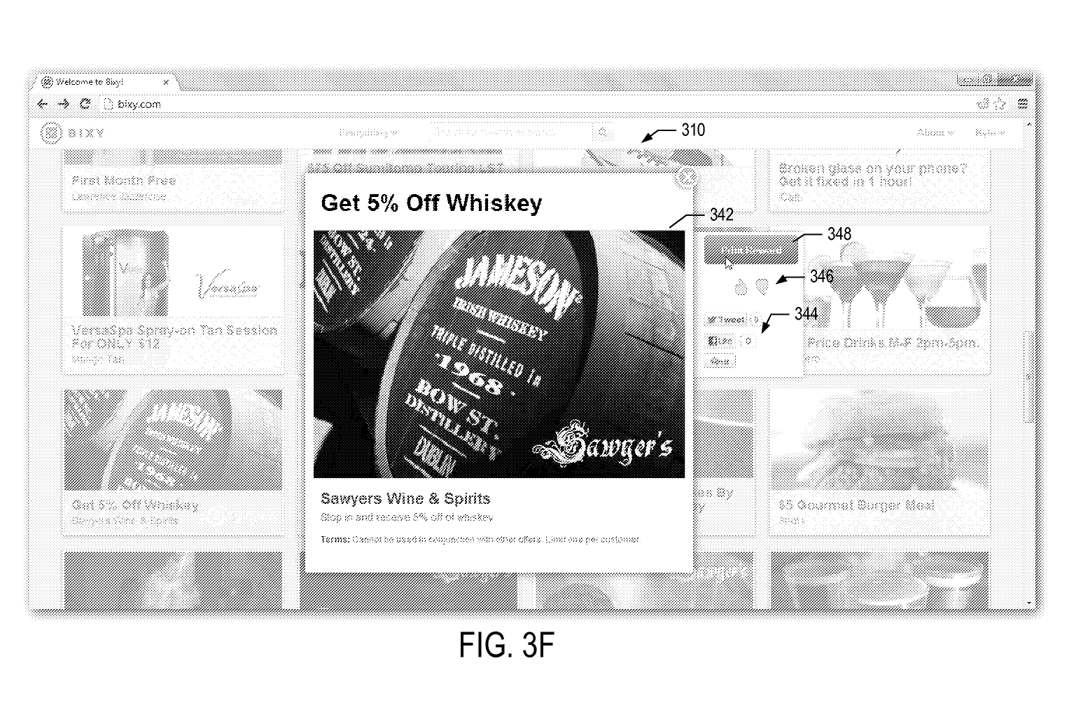

Another ad types, the offer for sale ad allows the Customer to click on a link within the ad to view more information about a product available for purchase from the advertised business. The customer can purchase the item and have it shipped to their home or pick-up the item in a store. In one aspect, the customer can make this purchase without ever leaving the original page with the ad on it. In this aspect, the customer may be debited through a customer profile established in the OTA system 102, as explained below with reference to FIGS. 3A-3F.

In another aspect, the targeted ad may be a product listing ad. Upon clicking a product listing ad, the customer may be directed to another website to purchase an item. For example, the customer may purchase the item directly from the advertised business's online retail website.

In various aspects, the offer for sale ads and the product listing ads may be created by an advertiser accessing the OTA system 102 through the computing device 104. Alternately, the OTA system 102 may create these ads dynamically by communicating with an online catalog for the advertised business's online retail website. For example, the OTA system 102 may request one or more data files, including still images, video, and text through an API call to the online catalog. The dynamically created ad may be populated with data previously provided by the advertiser. Conversely, the dynamically created ad may be populated with relevant data identified by the OTA system 102 as being relevant to the target audience. The relevant data may include information relevant to the demographic and interest data of the customer. When an item is sold, through a target ad, a percentage of the sale prices of the product may be debited form the advertisers account.

The OTA system 102 may also be used to create loyalty ads where the Customer can click on a link in the ad to view a displayed form where the customer may sign up for a loyalty program associated with the advertised business.

In one aspect, the costs for each advertising campaign are calculated using the equation: Ad Cost=(Base Cost)+Interactive Cost. The base cost is further determined by weighing a number of factors including the size of the target audience, the number of demographic or interest data matches with each customer who views the ad, an ad unit base cost, and an optional priority premium. In particular, the size of the target audience is calculated to quantify the supply of customers with matching demographics and the demand of advertisers to reach these customers. Similarly, more stringent matching criteria for the demographic and interest data matching will increase the cost of the advertisement. For example, an ad campaign targeting 18 to 30 year old females within 10 miles of Lawrence, Kans., may cost a first price. However, if the advertiser desires to narrow this group to those only interested in running, the costs will increase. The ad unit base cost varies with the different layouts and media types used in the advertisement. In addition, advertisers may elect to pay an optional premium to secure first priority in publishing their ads. The priority premium ensures that an advertiser's ad are published more often.

The Interactive Cost is dependent on the interactive-nature of the advertisement. For example, each of the different interactive ads previously described has a unique interactive cost. The interactive cost are incurred by the advertiser when the customer clicks or interacts with the advertisement. By way of example and not limitation, the interactive costs for each advertisement campaign may be in a range between $1.00 and $60.00 per one thousand advertisements. Moreover, more targeted or focused ads may cost more.

In another aspect, the advertising rate or value per impression (VPM) that is charged to each advertiser may be determined by the equation: VPM=PDI+CPM; where PDI (Projected Deal Income) is the revenue expected to result from selling the particular item and CPM (Up-front pricing) is the revenue paid by advertisers to deliver ads. In various other aspects, any other pricing model for on-line advertising may be used.

In addition to creating the advertisements, the TAO system 102 allows the advertiser to determine on which publisher products their ads will run on. For example, the advertiser may wish to prevent a particular publisher from displaying their ads. Similarly, advertisers can also make display selections or prohibitions by broader website categories. For instance, an advertiser may not wish to run their ads on religious websites.

In one aspect, the TAO system 102 allows the advertiser to control the number of times a reward or coupon is delivered to customers. For example, an advertiser may only want a customer to use a single coupon for the advertiser within a three-month period. However, the advertiser may run six coupons during that time frame. In this case, once a customer has placed a coupon from this advertiser within their “My Rewards” folder, the customer will no longer be offered another coupon by the advertiser until the 3-month time period expires.

The advertiser web portal 200 also allows advertisers to track and fulfill any rewards obtained by the customers who have clicked on the targeted ads. As shown in FIG. 2K, a user interface display 220 provides the advertisers with the date 236 and reward 238 for each customer 240 that may redeem or has redeemed an award, as indicated by 242. In one aspect, when a customer, especially a customer within the ads target audience, clicks on a targeted ad to earn a reward, the TAO system 102 generates a unique serial number 244 that is input into a data entry field 246 to be reconciled within the advertiser's profile as shown in FIG. 2L. In another aspect, data related to reward redemptions may be exported, as indicated by 248, to another data format, such as a spreadsheet, for use by the advertiser in their internal record keeping practices.

As shown in FIGS. 2M-2P, the advertiser web portal 200 includes user interface displays 250 and 262-266 that provide the advertiser with data indicative of the effectiveness of the targeted ads according to various demographic and interest data. For example, the interface display 250 displays the number of impressions 252, customer actions 254, likes 256, dislikes 258, and the costs 260 for the advertisers targeted ads based on the type of reward available. Similarly, interface displays 262-266 display the number of impressions 252, customer actions 254, likes 256, dislikes 258, and the costs 260 for the targeted ads based on the demographics, location and interests, respectively, of the customers. The data contained within each report display may be exported, as indicated by 248, to another data format, such as a spreadsheet, for use by the advertiser in their internal record keeping practices.

Advertisers that have an account on the TAO system 102 may view an overview of their ad campaigns in a “Dashboard” user interface display 220, as shown in FIG. 2Q. The dashboard interface display 220 provides a single display where the advertiser may view the status 236 and type 238 of all of their ad campaigns, as well as the number of impressions 252, customer actions 254, likes 256, dislikes 258, and the costs 260 incurred for each ad campaign.

Referring now to FIGS. 3A-3F, the TAO system 102 also generates a customer oriented web portal 300, similar to the advertiser web portal 200. In various aspects, the web portal 300 includes a number of user interface displays 302-324 that allow customers to create a user account on the TAO system 102 or alternately sign-in to an existing account.

Upon accessing the TAO system 102 over the communication network 110, the web portal 300 first provides customers with an introductory user interface display 302, shown in FIG. 3A. In one aspect, the introductory interface display presents one or more randomly selected targeted advertisements 120. In other aspects, the introductory interface display 302 may display advertisements 120 targeted to the general location from associated with the customers' IP address. The introductory interface display 320 may also be populated with advertisements 120 targeted to a customer previously associated with the IP address.

A returning customer may be signed-in to the web portal automatically based upon one or more HTTP cookie residing on the computing device 108. Alternately, a customer may sign-in to the web portal 300 by providing their account credentials into a data form 326, as shown in FIG. 3B.

In the instance, where the customer is establishing a new user account on the TAO system 102, the customer may provide demographic data and interest data to create a user profile. The customer's demographic data and interest data may be input in to data fields 328-338 on user interface displays 304-306, as shown in FIGS. 3C-3D. The customer may identify more than one location and may indicate a radius 338 around each location from which the customer desires to view targeted advertisements. Alternately, the customers may opt to have their demographic and interest data populated automatically based on information found in one or more of the customers existing social network profiles, such as a Facebook, Google+, or LinkedIn profile, among others. For example, the customer may log in to the TAO system 102 using their social network credentials, generally indicated at 340, as shown in FIG. 3B. Similarly, the customer may link and therefore associate their customer profile with their, among others. As previously described, the customer demographic and interest data may be used to determine the most appropriate audience for the targeted advertisements 120. By providing the demographic data and interest data, the customer is able to select and control the advertisements that they see. This allows customers to view advertisements for which they have already displayed some level of interest. Conversely, the advertisers are now able to increase the efficiency and effectiveness of their advertisement campaigns.

The web portal 300 also includes user interface displays, such as the user interface display 308, shown in FIG. 3E that allows the customer to view the coupons and rewards available to them. As described, the coupons and rewards may be presented to the customer in exchange for interacting with the various advertisements presented to the customer through the publishers' websites. In various aspects, the type and value of the reward may depend on the level of interaction by the customer. For example, customers who take a survey or play a game may receive a reward or coupon of greater value than another customer who simply clicks on a link to visit the advertiser's website. Similarly, “liking,” “pinning,” or sharing an advertisement may earn a customer greater rewards than simply viewing the advertisement.

FIG. 3F depicts a user interface display 310, where the customer is able to view a coupon and reward 342 at any time. In addition, the customer may share, as indicated by 344 any of the advertisements, and/or associated coupons and rewards with their friends on social networking sites. In one aspect, the customer may indicate and follow one or more advertisers or their particular brands by clicking on an interactive element 346. Therefore, upon signing into the web portal 300, the customer may always be presented with advertisements from these preferred businesses. In another aspect, the customer may rate the advertisements created by the advertisers. For example, the customer may rate the ad on a scale of 1 to 10 or simply indicate whether they like or dislike the ad. Other methods to rate the advertisement may also be used. The advertisement feedback process allows the customer to further optimize the targeting efforts of the advertiser to ensure that the helps businesses create better ads by receiving feedback.

The user interface display 310 also allows the customer to redeem a coupon or reward acquired through the TAO system 102. For example, the customer may print the coupon or reward by clicking on an interactive element 348 to obtain a physical copy of the coupon/reward during redemption. Alternately, the user interface display 310 may be accessed using the customer's smart phone or other mobile device, and a graphic representation of the coupon or reward may be presented for redemption. In one embodiment, the web portal 300 allows the customer to view a history of the items they have purchased as well as viewing items suggested for future purchase.

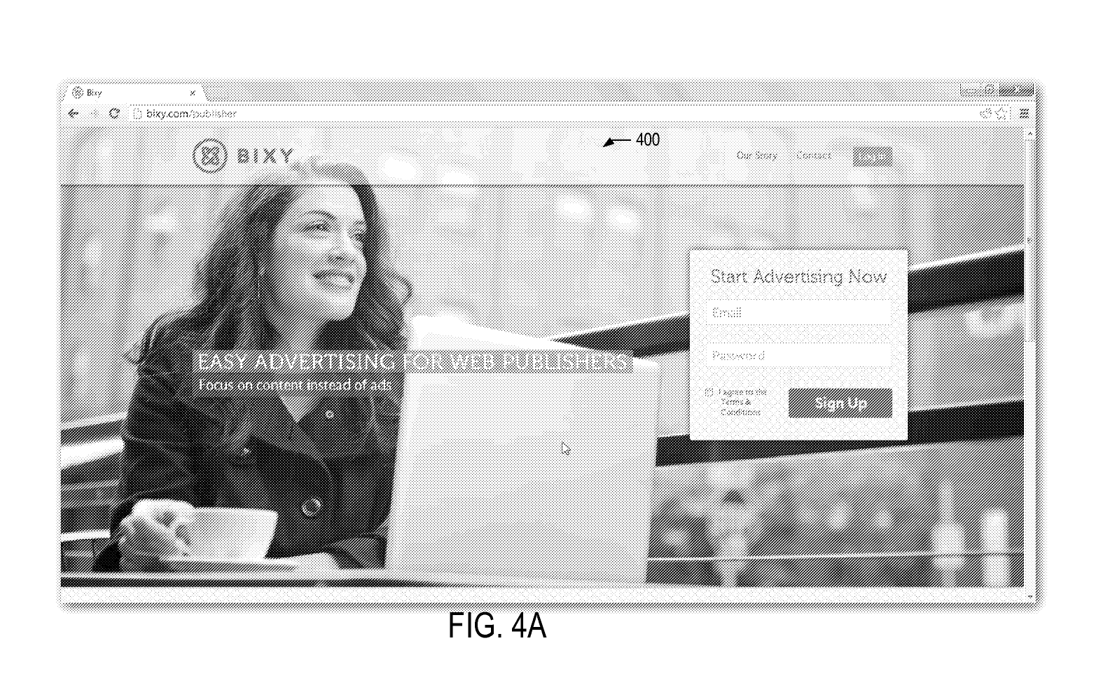

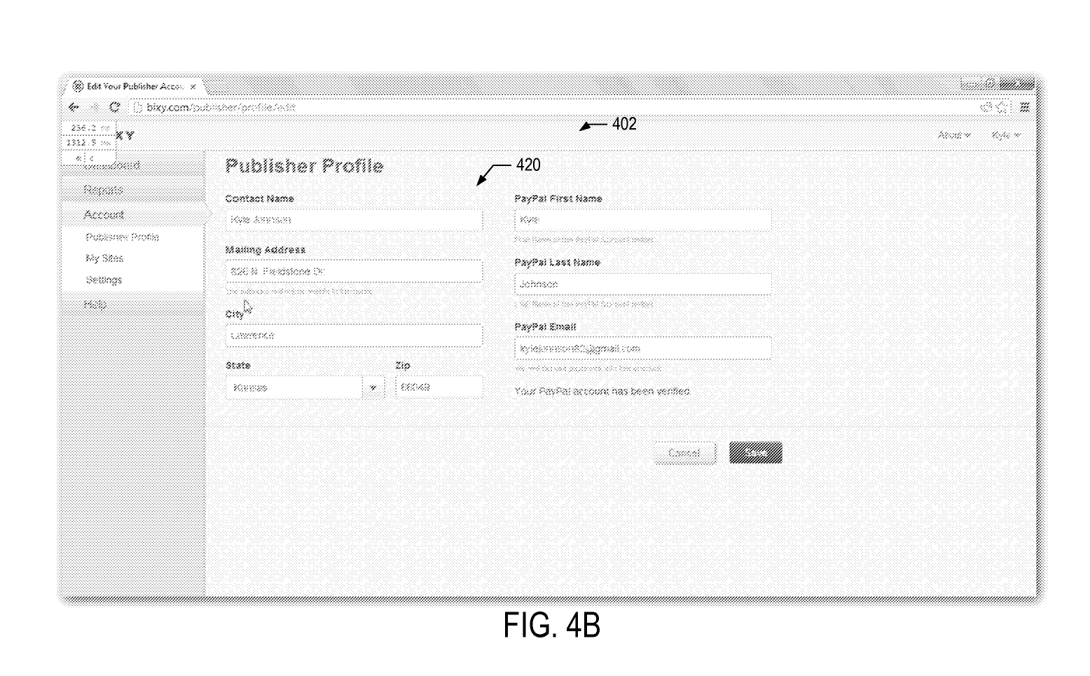

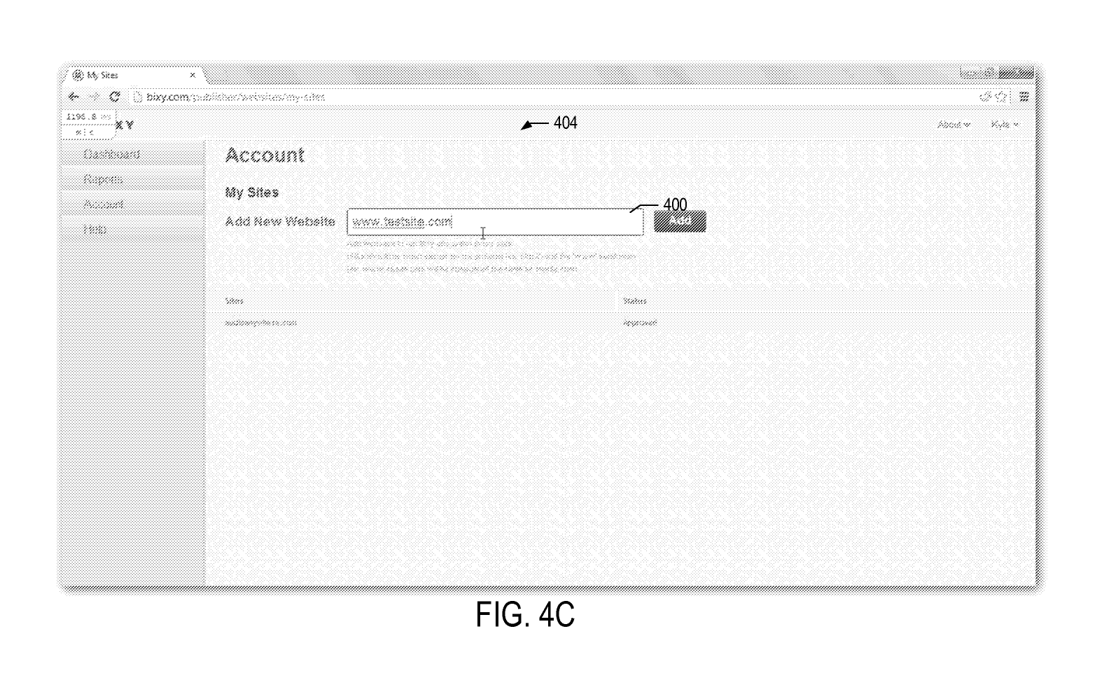

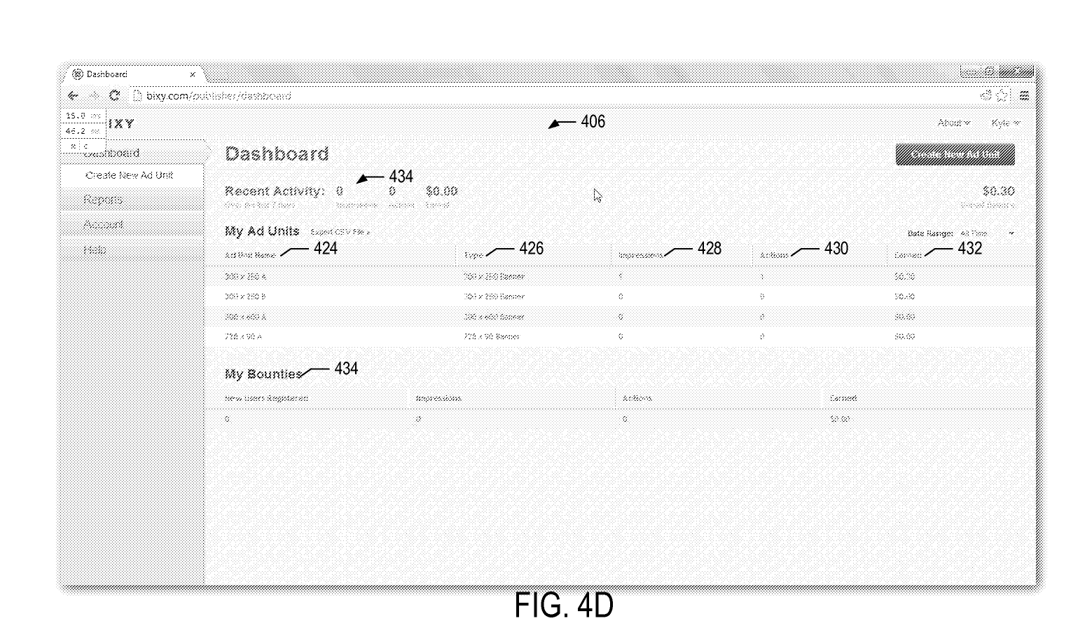

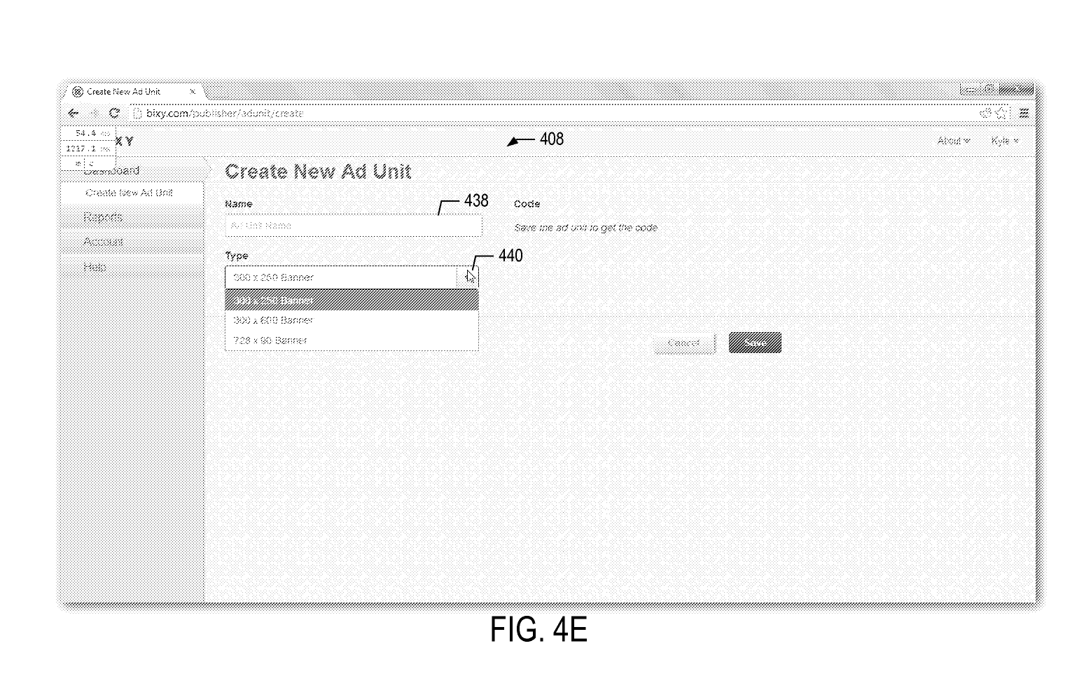

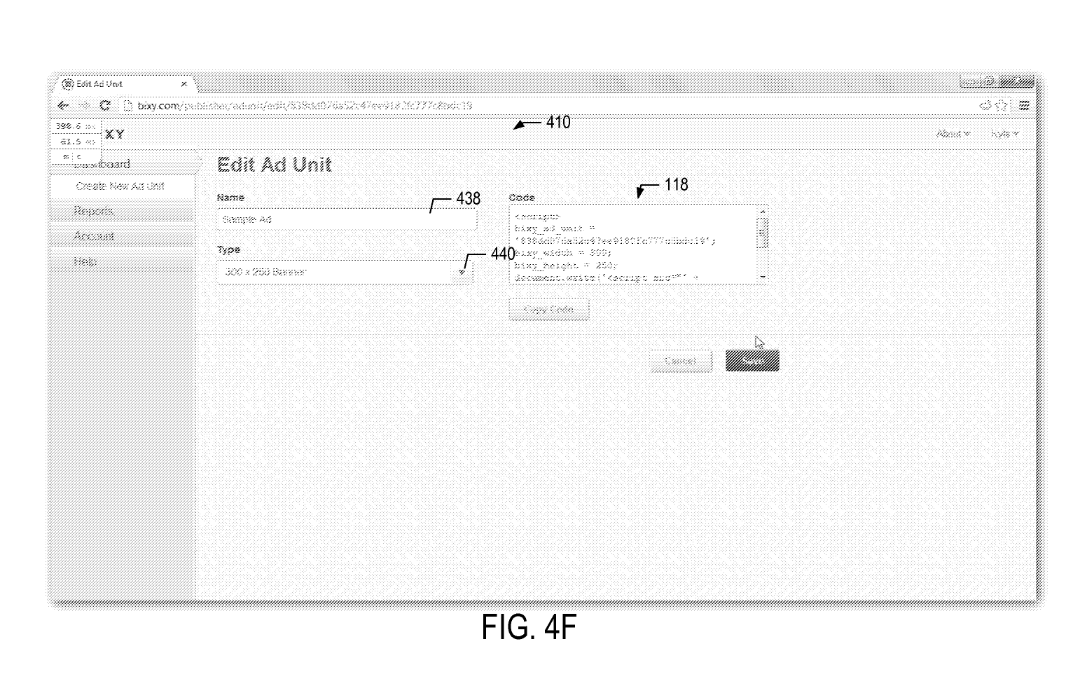

In one aspect, the TAO system 102 also presents a web portal 400 for online content publishers. The web portal 400 is similar to web portal 200 for advertisers. In one aspect, the publisher web portal 400, allows the publisher to create a single account linked to all of the content products, including but not limited websites, mobile applications, and other software, owned by the publisher. Conversely, the publisher may also create individual profiles for the content products or groups thereof. The web portal 400 also includes user interface displays, such as the user interface displays 402 and 404, shown in FIGS. 4B-4C, that allow a publisher to create or edit their account on the TAO system 102. In one aspect, the publisher may input data in the form 420 and data entry field 422 to provide their name, address, payment information, and identify their website(s) or other products.

The publisher web portal 400 also includes a “Dashboard” user interface display 406, as shown in FIG. 4D. The dashboard interface display 406 provides a single display where the publisher may view the ad unit name 424 and the ad layout dimension 426 of each of the ad spaces that the publisher populates with target advertisements. The dashboard interface display 406 also displays the number of impressions 428, customer actions 430, and earnings 432 for each ad space. The dashboard also indicates any recent activity 434 relevant to the publisher's account, as well as any bounties 436 earned by the publisher. In one aspect, the information presented in the dashboard interface display 406 may be further delineated and presented through additional user interface displays that present individual reports that correspond to the ad units, the publisher's products, earned bounties, and the publisher's earnings.

In one aspect, the TAO system 102 permits the publisher to earn a bounty 436 for new customers that create a profile on the TAO system 102, after viewing one or more targeted advertisements on at least one of the publisher's products. In this aspect, the publisher has an additional incentive to publish relevant targeted ads that may earn additional revenue for the publisher through the bounty program.

User interface displays 408-410, as shown in FIGS. 4E and 4F, allow the publisher to create or modify ad units, respectively. For example, the publisher may create a new ad unit on one or more of their products by inputting data into the data entry fields 438 and 440. After creating and saving a new ad unit, the TAO system 102 generates a targeted advertisement reference 118 for the newly created ad unit. In one aspect, targeted advertisement reference 118 includes another reference to a script or other executable application that may then populate the new ad unit with a targeted advertisement.

In one embodiment, the publisher may choose what types of ads they wish to display on their products and the frequency with which the ads are displayed. For example, the advertisements may be selected based on data size, layout dimensions, media type, and content type, and the content itself. The publisher can specify what types of ads, and therefore targeted advertisement reference(s) 118 should be generated, or alternatively, excluded from their products when a customer views content on those products. This decision may be based on particular brands or keywords. Additionally, the publisher can choose to not allow ads meant for a specific audience, such as those designed for adult consumption. By way of example, a publisher may wish to exclude ads containing sexual references, violence, alcohol, or tobacco.

In one aspect, the publisher web portal 300 may present the publisher with information regarding the effectiveness of each advertisement, similar to the user interface displays 250 and 262-266 of the advertiser web portal 200. Therefore, publishers may see how ads delivered by the TAO system 102 are performing on their products in order to make decisions regarding the continued publication of advertising or even the inclusion of additional ad units.

In another aspect, the web portal 400 allows each publisher to view an aggregate of the profiles for customers who view content through the publishers' products. The aggregate profile data may be may be compiled stored in the database 116, is used to identify the common characteristics of customers and other visitors accessing the publishers products. Based, at least on part on this data, the TAO system 102 can provide one or more recommendations to each publisher to potentially improve the number of visitors or users of their products and thereby increase their revenue.

Similarly, the publishers can share their own proprietary data regarding the visitors to their products or properties with the TAO system 102. Similarly, the publishers may store visitor and customer data from the TAO system database 116 in their own databases in their preferred formats. For example, the TAO system 102 permits the publishers to access some data in the TAO system database by exporting the data from one or more user interface displays of the web portal 400. Alternately, the publishers may communicate with the TAO system 102 through a call from the computing device 106 to an application programming interface (API) of the targeted application 114 via the communication network 112.

The TAO system 102 allows the publisher to augment the data known about the customers that have accounts with the TAO system by providing content specific details to the TAO system via the API. For example, the publisher may provide data to the TAO system 102 via the API indicating that a web page 156 currently being viewed by the customer contains information relevant to one or more ads stored in the database 116. For instance, if the customer is reading an on-line article about a new novel, the publisher will communicate this data to the TAO system 102. The TAO system 102 may return a targeted advertisement reference 118 for that novel, the Author, the publisher, or other related products. In this aspect, the targeted advertisement reference 118 may point to an ad previously created by the book publisher or a retailer. Alternatively, the TAO system 102 may also produce a targeted ad on the fly by retrieving data from the online catalog or another database containing data about the products sold by the online retailer. In one aspect, the TAO system 102 may make a call to the API of an online retailer to retrieve media and text files for product. The TAO system 102 then assemblies an advertisement that corresponds to an ad unit of the publisher.

FIG. 6 is a block diagram that depicts an exemplary TAO system 102. According to one aspect, the TAO system 102 includes a processing system 112 that executes the targeted advertisement application 114 to create and/or manage advertisements. The processing system 112 includes a processor, and the processing system 112 can be a computer or other processor.

The targeted advertisement application 114 includes instructions or modules that are executable by the processing system 112 of the TAO system 102 to create and/or manage advertisements. The TAO system 102 includes a computer readable media 600 configured with the targeted advertisement application 114.

Computer readable media 600, which include volatile media, nonvolatile media, removable media, and non-removable media, may be another available medium that can be accessed by the TAO system 102. By way of example and not limitation, computer readable media 600 comprises computer storage media. Computer storage media includes volatile media, nonvolatile media, removable media, and non-removable media implemented via a method or technology for storage of information, such as computer readable instructions, data structures, program modules, or other data.

A user interface module 602 transmits the user interface displays of the web portals 200, 300, and 400 to the computing devices 104-108. For example, the user interface module 602 transmits the user interface display 208, 304, and 402 to the computing devices 104, 106, and 108, respectively.

An ad creation and storage module 604 receives the advertisement creation request 121 from a computing device used by an advertiser. The ad creation and storage module also receives advertisement components, such as media files and text received from the advertiser. The ad creation and storage module 604 creates the targeted advertisement and stores the targeted advertisement in the advertisement database 116. The ad creation and storage module 604 also generates the targeted advertisement record 119 containing the advertisement data 500, media files 504, and optionally the business date 502 for each target advertisement created. In one aspect, the ad creation and storage module 604 may transmit the target advertisement to the advertisement hosting server 130 for storage and publication.

An assignment module 606 assigns a targeted advertisement reference 118 to each target advertisement. In one aspect, the assignment module 606 generates targeted advertisement reference 118 as a data string that may be provided to the publishers for inclusion in their content.

An advertisement view request module 608 receives an advertisement view request 122 from the computing device 108, based upon the customer visiting or using a product operated by the publisher. In response to the advertisement view request 122, the advertisement view request module 608 identifies the customer that originated the view request. In one aspect, the advertisement view request module 608 identifies the customer by an IP address or HTTP cookie. The advertisement view request module 608 then determines if the customer has a customer profile on the TAO system 102.

The advertisement view request module 608 may then identify a particular targeted advertisement reference 118 and targeted advertisement 120 in response to identifying the customer. For example, the advertisement view request module 608 may compare the demographic and interest data in the customer profile to the targeted advertisement record(s) 119 for each targeted advertisement. Typically, the targeted advertisement record 119 that most closely matches the customer's demographics and interests is selected for subsequent publication. In other aspects, however another advertisement may be selected. For example, the advertisement record 119 that would ordinarily be selected may be ignored if the customer has indicated a dislike for the advertised business or if the customer is viewing content within which the advertiser has declined to be published.

An advertisement recommendation module 610 may identify and recommend one or more other targeted advertisements and targeted advertisement reference 118 that should be transmitted to the computing device 108. For example, the customer may view a website having a layout for positioning and displaying three advertisements of differing dimensions. If the targeted advertisement application 114 determines that only one of the three advertisement positions corresponds to the dimensions of a targeted ad, the advertisement recommendation module 610 may recommend one or more other advertisements for the two remaining layout positions. In this example, the recommended advertisements may not as stringently match the demographic and interest data of the user as precisely as other ads. The OTA system 102 will recommend the most appropriate advertisement in the database 116, as determined by data input by the advertiser, publisher, and customer that also matches the dimensions of the layout positions in the website. In addition, the recommendation module 610 may recommend an alternate advertisement, when a customer preference or an advertiser preference precludes publishing what would typically be the most suitable advertisement.

A publishing module 612 sends or transmits the targeted advertisement reference 118 to the customer via the publisher's product. The publishing module also retrieves the targeted advertisement when the targeted advertisement reference 118 not a URL code.

A reporting module 614 creates generates and stores view request data regarding the request 122 for each targeted advertisement 120. The view request data is used to calculate the funding costs and/or payments, as well as being used in the data presented in the interface displays 262-266 as shown in FIGS. 2M-2P.

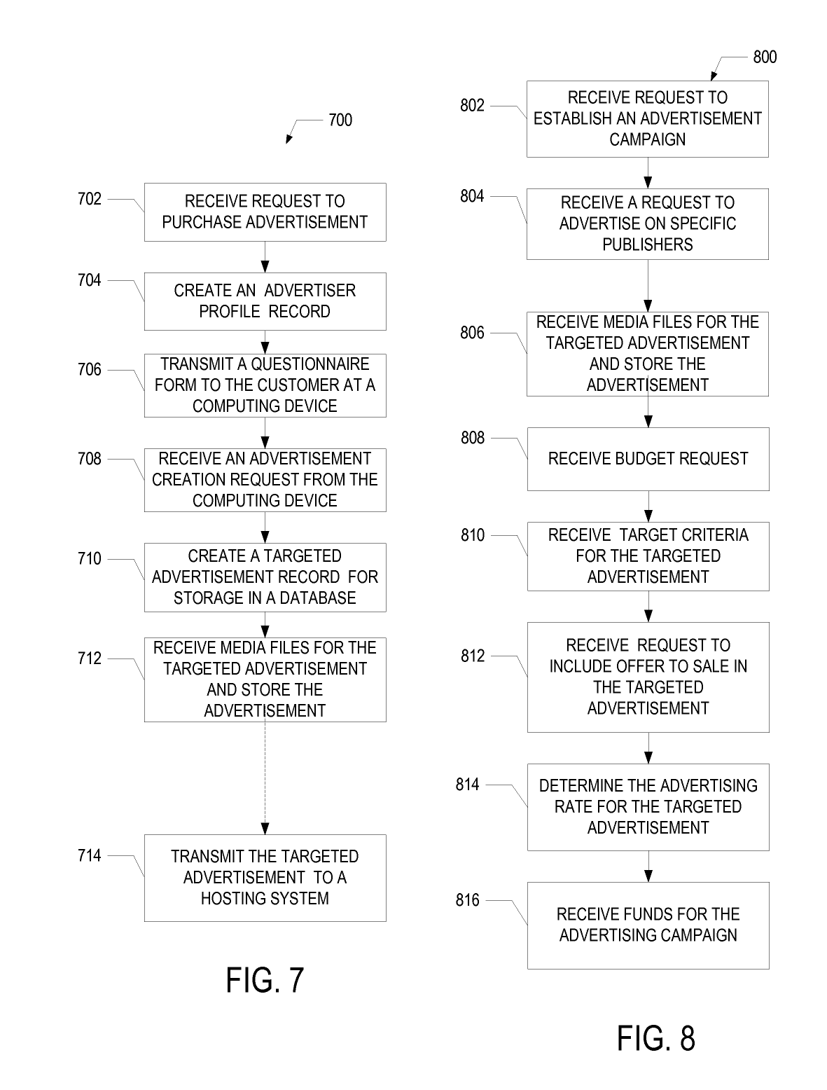

FIG. 7 illustrates a method 700 to create and publish targeted advertisements in accordance with an aspect of the advertisement application 114. At 702, an advertiser sends a request to purchase an advertisement to the TAO system 102. In another embodiment, the request may be made through a publisher that receives ads from the TAO system 102. An advertiser profile is created for the advertiser by advertisement creation application 114, if a profile does not already exist at 704. The advertiser profile may include identifying data about the advertiser. The advertiser profile may also include authentication data, such as username and password, account information, and other information about the advertiser. At 706, the advertisement creation application 114 transmits an advertisement creation interface display, such as the interface display 208, to the advertiser at the computing device 104. The advertiser inputs data into the advertisement creation interface display 208 to describe their business, product, and/or service. The advertiser generates an advertisement creation request 114 at the computing device 104 by completing the advertisement creation interface display 208. At 708, the targeted advertisement application 114 receives the advertisement creation request 114 from the computing device 104 and associates the business data and advertisement data in the advertisement creation interface display 208 with the advertisement creation request 114. The targeted advertisement application 114 creates a targeted advertisement record 119 that includes the advertisement data and business data for storage in the TAO database 116 at 710.

At 712, the advertiser uploads the various media and text data that will be used in the targeted advertisement to the TAO system 102 for storage in the database 116. At alternative step 714, the targeted advertisement application 114 sends the targeted advertisement 120 to the advertisement hosting system 130 for storage and publication. The hosting system 130 may then provide the targeted advertisement in response to an advertisement view request through a web site being operating by a publisher.

FIG. 8 illustrates another method 800 to create and manage an advertisement campaign in accordance with an aspect of the advertisement application 114. At 802, the advertiser creates a name advertisement campaign, establishes a date range for which the campaign will run. At, 804, the advertiser identifies the publishers and optionally, the specific products for the selected publisher. The advertiser creates the advertisement(s) by interacting with the user interface display 208, as shown in FIGS. 2C-D, to input data and upload files at 806. At 808, a budget for the advertising campaign created at 802 is determined by the advertiser and the target audience for the campaign is identified at 810 using with the user interface displays 214 and 216, as shown in FIGS. 2G-2I. At 812, the advertiser indicates if the ad campaign will permit a product to be sold directly to the customer, wherein additional information regarding the product, price, shipping costs, and other data relevant to the offer for sale.

Based at least in part on the data received from the advertiser at 802-812, the TAO system 102 determines an advertising rate per thousand impressions at 814. After reviewing the created ad campaign and reviewing the advertising rate determined at 814, the advertiser completes the ad campaign creation process and funds the campaign at 816.

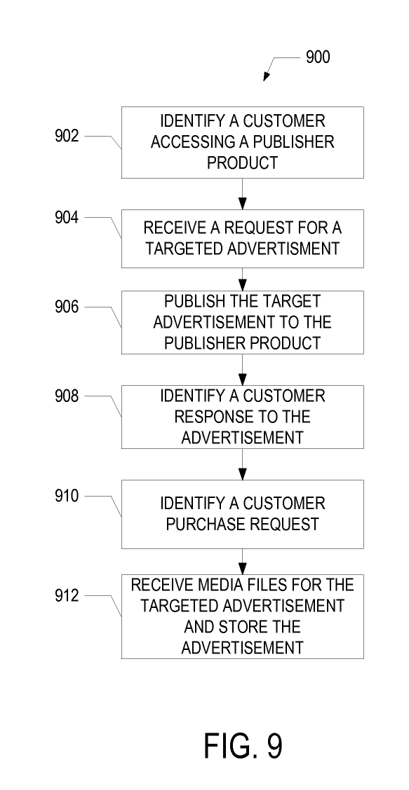

FIG. 9 is a flowchart of a method 900 for publishing targeted advertisements with the TAO system 102. At 902, the TAO system 102 identifies a customer accessing a website or product of a publisher. While the customer is viewing or consuming the content published by the publisher, a request for a targeted advertisement reference 118 is received at the TAO system 102 at 904. In one aspect, the targeted advertisement provided by the TAO system 102 is matches at least two or more of the customer's age, gender, political views, interests, education, location, or other demographic data.

In one embodiment, where the customer does not have a customer profile on the TAO system 102, the targeted advertisements provided by the TAO system 102 are based on the location from which the customer access the publisher's product. For example, the publisher's product may transmit information regarding the IP address of the customer. The IP address may then be used to determine an approximate geographical location for the customer, such that advertisements relevant to the location may be provided. Similarly, advertisements may be selected based on the time of day, the product, or the previous behavior of a user from the same IP address or location.

In another embodiment, where the customer has created customer profile on the TAO system 102 using the web portal 300, the customer may be identified by one or more HTTP cookies, residing on the computing device 108. In one aspect, the one or more HTTP cookies are transmitted to the computing device 108 each time the customer signs-in the TAO system 102, interacts with an ad, or redeems a reward. In this embodiment, the targets advertisements provided by the TAO system 102 are based on the demographic data, interests, and customer preferences indicated by customer through the web portal 300.

At 906, the publisher displays the selected target advertisement and the TAO system 102 determines if the customer “consumes” the advertisement by clicking on the advertisement at 908. The TAO system 102 stores data in response to the customer clicking on the selected advertisement. This data is used for further optimization as well as for debiting the advertiser account for the impression. In addition, this data may be used to populate the customers TAO system profile with one or more coupons or rewards, based upon clicking the targeted advertisement. At 910, the TAO system 102 determines if the customer has purchased a product based on the targeted advertisement and debits the advertiser account at 912, if necessary.

In one aspect, the TAO system 102 unifies the advertisment viewing experience for the customer across all of the publisher products for the publishers having a profile on the TAO system 102. For example, a customer will be presented with the same or similar targeted ads, as determined by the TAO system 102, on all the products owned by those publishers using the TAO system.

In another embodiment, OTA system 102 may receive data from content owners that are not publishers. For example, the media within the advertisements may be purchased or licensed from creative content providers. In this embodiment, TAO system 102 may be accessed by a videographer, photographer, artist, or music producer, among others, to promote and license their creative works for use in target advertisements.

Those skilled in the art will appreciate that variations from the specific embodiments disclosed above are contemplated by the invention. The invention should not be restricted to the above embodiments, but should be measured by the following claims.

What is claimed is:

1. A system for creating targeted advertisements for display, the system comprising:
a database to store a plurality of targeted advertisement records, targeted advertisements, and targeted advertisement references and data; and
a computing device comprising at least one processor for executing a targeted advertisement application, the a targeted advertisement application further comprising:
modules executable by the at least one processor, the targeted advertisement application comprising:
an ad creation and storage module:
receive an advertisement creation request from a computing device;
create a targeted advertisement based on the advertisement creation request;
generate a targeted advertisement record comprising advertisement data, wherein the advertisement data includes demographic data and interest data of the target audience; and
store the targeted advertisement in a database;
an assignment module to:
generate a targeted advertisement reference for the targeted advertisement; and
assign the targeted advertisement reference to the targeted advertisement; and
an advertisement view request module to:
receive an advertisement view request from another computing device;
identify a user of the other computing device; and
determine if the user of the other computing device is a member of a target audience for the targeted advertisement.

2. The system of claim 1, wherein the targeted advertisement record further comprises business data, wherein the business data includes data on an advertised business and a reward associated with the targeted advertisement.

3. The system of claim 1, further comprising the advertisement view request module to:
compare demographic and interest data of the user to the targeted advertisement record; and
determine if the targeted advertisement can be transmitted for publication.

4. The system of claim 1, further comprising an advertisement recommendation module to:
identify another targeted advertisement and another targeted advertisement reference when the user is not a member of the target audience for the targeted advertisement.

5. The system of claim 1, further comprising an reporting module to:
generate view request data in response to the advertisement view request, wherein the view request data is used to determine a cost for publishing the targeted advertisement; and
store the view request data in database.

6. The system of claim 1, further comprising user interface module to:
generate a first user interface for receiving the advertisement creation request;
generate a second user interface for receiving demographic and interest data from the user; and
generate a third user interface for receiving the advertisement view request.

7. The system of claim 6, wherein:
the first user interface module receives the advertisement creation request from an advertiser using the computing device;
the second user interface receives the demographic and interest data for the user from the other computing device; and wherein the
third user interface receives the advertisement view request from a publisher providing content to the other computing device.
